(19) United States
(12) Patent Application Publication
(10) Pub. No.: US 2016/0154570 A1
(43) Pub. Date: Jun. 2, 2016

(54) ITERATIVE SUGGESTION MODES FOR REAL-TIME COLLABORATIVE INTELLIGENCE SYSTEMS

(71) Applicant: Unanimous A. I., Inc., San Francisco, CA (US)

(72) Inventor: Louis B. Rosenberg, San Luis Obispo, CA (US)

(21) Appl. No.: 15/017,424

(22) Filed: Feb. 5, 2016

Related U.S. Application Data
(63) Continuation-in-part of application No. 14/668,970, filed on Mar. 25, 2015.
Application No. 14/668,970 is a continuation-in-part of application No. 14/708,038, filed on May 8, 2015.
Application No. 14/708,038 is a continuation-in-part of application No. 14/738,768, filed on Jun. 12, 2015.
Application No. 14/738,768 is a continuation-in-part of application No. 14/859,035, filed on Sep. 18, 2015.
Application No. 14/859,035 is a continuation-in-part of application No. 14/920,819, filed on Oct. 22, 2015.
Application No. 14/920,819 is a continuation-in-part of application No. 14/925,837, filed on Oct. 28, 2015.
(60) Provisional application No. 62/113,393, filed on Feb. 7, 2015.
(60) Provisional application No. 61/970,885, filed on Mar. 26, 2014.
(60) Provisional application No. 61/991,505, filed on May 10, 2014.
(60) Provisional application No. 62/012,403, filed on Jun. 15, 2014.
(60) Provisional application No. 62/066,718, filed on Oct. 21, 2014.
(60) Provisional application No. 62/067,505, filed on Oct. 23, 2014.
(60) Provisional application No. 62/069,360, filed on Oct. 28, 2014.

(30) Foreign Application Priority Data
Oct. 20, 2015 (US) PCT/US15/56394

(51) Int. Cl. G06F 3/0484; H04L 29/06; G06F 3/0482

(52) U.S. Cl. CPC G06F 3/04842; G06F 3/0482; H04L 65/403

(57) ABSTRACT

Systems and methods for real-time collaborative computing and collective intelligence are disclosed. A collaborative application runs on a collaborative server connected to a plurality of computing devices. Collaborative sessions are run wherein a group of independent users, networked over the internet, collaboratively answer questions in real-time, thereby harnessing their collective intelligence. Systems and methods for iterative selection among a set of user-input suggestions.

This application claims the benefit of U.S. Provisional Application No. 62/113,393 entitled SYSTEMS AND METHODS FOR ENABLING SYNCHRONOUS COLLABORATIVE CREATIVITY AND DECISION MAKING, filed Feb. 7, 2015, which is incorporated in its entirety herein by reference.

This application is a continuation-in-part of U.S. application Ser. No. 14/668,970 entitled METHODS AND SYSTEMS FOR REAL-TIME CLOSED-LOOP COLLABORATIVE INTELLIGENCE, filed Mar. 25, 2015, which in turns claims the benefit of U.S. Provisional Application 61/970,885 entitled METHOD AND SYSTEM FOR ENABLING A GROUPWISE COLLABORATIVE CONSCIOUSNESS, filed Mar. 26, 2014, both of which are incorporated in their entirety herein by reference.

This application is a continuation-in-part of U.S. application Ser. No. 14/708,038 entitled MULTI-GROUP METHODS AND SYSTEMS FOR REAL-TIME MULTI-TIER COLLABORATIVE INTELLIGENCE, filed May 8, 2015, which in turns claims the benefit of U.S. Provisional Application 61/991,505 entitled METHODS AND SYSTEM FOR MULTI-TIER COLLABORATIVE INTELLIGENCE, filed May 10, 2014, both of which are incorporated in their entirety herein by reference.

This application is a continuation-in-part of U.S. application Ser. No. 14/738,768 entitled INTUITIVE INTERFACES FOR REAL-TIME COLLABORATIVE INTELLIGENCE, filed Jun. 12, 2015, which in turns claims the benefit of U.S. Provisional Application 62/012,403 entitled INTUITIVE INTERFACE FOR REAL-TIME COLLABORATIVE CONTROL, filed Jun. 15, 2014, both of which are incorporated in their entirety herein by reference.

This application is a continuation-in-part of U.S. application Ser. No. 14/859,035 entitled SYSTEMS AND METHODS FOR ASSESSMENT AND OPTIMIZATION OF REAL-TIME COLLABORATIVE INTELLIGENCE SYSTEMS, filed Sep. 18, 2015 which in turns claims the benefit of U.S. Provisional Application No. 62/066,718 entitled SYSTEM AND METHOD FOR MODERATING AND OPTIMIZING REAL-TIME SWARM INTELLIGENCES, filed Oct. 21, 2014, both of which are incorporated in their entirety herein by reference.

This application is a continuation-in-part of U.S. application Ser. No. 14/920,819 entitled SUGGESTION AND BACKGROUND MODES FOR REAL-TIME COLLABORATIVE INTELLIGENCE SYSTEMS, filed Oct. 22, 2015 which in turns claims the benefit of U.S. Provisional Application No. 62/067,505 entitled SYSTEM AND METHODS FOR MODERATING REAL-TIME COLLABORATIVE DECISIONS OVER A DISTRIBUTED NETWORKS, filed Oct. 23, 2014, both of which are incorporated in their entirety herein by reference.

This application is a continuation-in-part of U.S. application Ser. No. 14/925,837 entitled MULTI-PHASE MULTI-GROUP SELECTION METHODS FOR REAL-TIME COLLABORATIVE INTELLIGENCE SYSTEMS, filed Oct. 28, 2015 which in turns claims the benefit of U.S. Provisional Application No. 62/069,360 entitled SYSTEMS AND METHODS ENABLING AND MODERATING A MASSIVELY PARALLEL REAL-TIME SYNCHRONOUS COLLABORATIVE SUPER-INTELLIGENCE, filed Oct. 28, 2014, both of which are incorporated in their entirety herein by reference.

This application is a continuation of International Application No. PCT/US15/56394, filed Oct. 20, 2015.

### BACKGROUND OF THE INVENTION

1. Field of the Invention

The present invention relates generally to systems and methods for collaborative intelligence, and more specifically to systems and methods for closed-loop, dynamic collaborative intelligence.

2. Discussion of the Related Art

Portable computing devices, such as cell phones, personal digital assistants, and portable media players have become popular personal devices due to their highly portable nature, their ability to provide accessibility to a large library of stored media files, their interconnectivity with existing computer networks, and their ability to pass information to other portable computing devices and/or to centralized servers through phone networks, wireless networks and/or through local spontaneous networks such as Bluetooth® networks. Many of these devices also provide the ability to store and display media, such as songs, videos, podcasts, ebooks, maps, and other related content and/or programming. Many of these devices are also used as navigation tools, including GPS functionality. Many of these devices are also used as personal communication devices, enabling phone, text, picture, and video communication with other similar portable devices. Many of these devices include touch screens, tilt interfaces, voice recognition, and other modern user input modes. As a result, the general social trend within industrial societies is that every person does now or soon will maintain at least one such multi-purpose electronic device upon their person at most times, especially when out and about.

While such devices allow accessing information and person to person communication, they do not provide any unique tools and infrastructure that specifically enable groups of electronically networked individuals to have a real-time group-wise experience that evokes the group's collaborative intent and intelligence (Collaborative Consciousness). Hence, there is a substantial need to provide tools and methods by which groups of individuals, each having a portable computing device upon their person, to more easily contribute their personal will/intent to an emerging collaborative consciousness, allowing the group to collectively answer questions or otherwise express their groupwise will in real-time. Furthermore, there is a need to provide tools and methods that enable groups of users to be informed of the group-wise will that is emerging in real-time. The present invention, as described herein, addresses these and other deficiencies present in the art.

### SUMMARY OF THE INVENTION

Several embodiments of the invention advantageously address the needs above as well as other needs by providing an iterative suggestion selection process for a group of users in real-time collaborative control of at least one graphical object, each user of the group associated with one of a plurality of computing devices, each computing device including a display interface, configured to exchange data with a collaboration server, and run a collaboration application, the collaboration server performing the steps of: receiving, during a suggestion period, from the plurality of computing devices, a plurality of representations of suggestions; adding each of the plurality of representations of suggestions to a suggestion list; determining that a number of representations of suggestions of the suggestions list is greater than a pre-determined number of answer choices; selecting a first subset of the plurality of representations equal to the number of answer choices; sending an indication of the first subset to the plurality of computing devices; moderating a collaborative selection process, whereby a first target is collaboratively selected from the first subset by the group of users; while a number of representations of suggestions not previously included in at least one collaborative selection process is greater than a pre-determined number of answer choices minus one, repeatedly performing the steps of; selecting a revised subset of the plurality of representations, wherein the revised subset excludes all representations of suggestions previously included in one collaborative selection process but not selected as the target, and wherein the subset includes the target of the previous collaborative selection process; sending an indication of the revised subset to the plurality of computing devices; and moderating a next collaborative selection process, whereby a revised target is collaboratively selected from the revised subset by the group of users; selecting a final subset of the plurality of representations, wherein the revised subset excludes all representations of suggestions previously included in at least one collaborative selection process but not selected as the target, and wherein the subset includes the target of the previous collaborative selection process; sending an indication of the final subset to the plurality of computing devices; and moderating a final collaborative selection process, whereby a final target is collaboratively selected.

In another embodiment, the invention can be characterized as a system for an iterative suggestion selection process for a group of users in real-time collaborative control of at least one graphical object, comprising: a group of a plurality of computing devices, each user of the group associated with a user, each computing device each comprising a communications infrastructure coupled to each of a processor, a memory, a timing circuit, a display interface coupled to a display and configured to receive input from a user; a collaborative intent application stored on each memory and configured to run on each processor to: convey to the user, using the display interface, a group collaboration opportunity, receive, repeatedly in real-time, user input of a user intent vector through the display interface, send, repeatedly in real-time, the user intent vector to a collaboration server, receive, repeatedly in real-time, a group intent vector from the collaboration server, and present, repeatedly in real-time, a graphical indication of the group intent vector to the user using the display interface; and the collaboration server in networked communication with the plurality of computing devices, the collaboration server including a server processor and a server memory, the processor configured to run a collaboration mediation application stored on the server memory, the collaboration mediation application configured to perform the steps of: receiving, during a suggestion period, from the plurality of computing devices, a plurality of representations of suggestions; adding each of the plurality of representations of suggestions to a suggestion list; determining that a number of representations of suggestions of the suggestions list is greater than a pre-determined number of answer choices; selecting a first subset of the plurality of representations equal to the number of answer choices; sending an indication of the first subset to the plurality of computing devices; moderating a collaborative selection process, whereby a first target is collaboratively selected from the first subset by the group of users; while a number of representations of suggestions not previously included in at least one collaborative selection process is greater than a pre-determined number of answer choices minus one, repeatedly performing the steps of; selecting a revised subset of the plurality of representations, wherein the revised subset excludes all representations of suggestions previously included in one collaborative selection process but not selected as the target, and wherein the subset includes the target of the previous collaborative selection process; sending an indication of the revised subset to the plurality of computing devices; moderating a next collaborative selection process, whereby a revised target is collaboratively selected from the revised subset by the group of users; selecting a final subset of the plurality of representations, wherein the revised subset excludes all representations of suggestions previously included in at least one collaborative selection process but not selected as the target, and wherein the subset includes the target of the previous collaborative selection process; sending an indication of the final subset to the plurality of computing devices; and moderating a final collaborative selection process, whereby a final target is collaboratively selected from the final subset by the group of users.

In yet another embodiment, the invention can be characterized as an iterative suggestion selection process for a group of users in real-time collaborative control of at least one graphical object, each user of the group associated with one of a plurality of computing devices, each computing device including a display interface, configured to exchange data with a collaboration server, and run a collaboration application, the collaboration server performing the steps of: receiving, during a first suggestion period, from the plurality of computing devices, a number of representations of suggestions equal to a number of displayed answer choices; adding each of the representations of suggestions to a first suggestion list; sending an indication of the first suggestion list to the plurality of computing devices, wherein the representations of suggestions are displayed as answer choices on each display interface; moderating a first collaborative selection process, whereby a target is collaboratively selected from the answer choices by the group of users; receiving, during an additional suggestion period, from the plurality of computing devices, a number of representations of suggestions no more than a number of displayed answer choices minus one; while a minimum number of suggestions is received in an allotted time, repeatedly performing the steps of; adding each of the representations of suggestions to a next suggestion list; sending an indication of the next suggestion list to the plurality of computing devices, wherein the representations of suggestions and the target are displayed as answer choices on each display interface; moderating a next collaborative selection process, whereby a new target is collaboratively selected from the revised subset by the group of users and the new target replaces the previously selected target; and receiving, during an additional suggestion period, from the plurality of computing devices, a number of representations of suggestions no more than a number of displayed answer choices minus one; and setting of the selected target as the final answer.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a schematic diagram of an exemplary real-time collaborative system.

FIG. 2 is an exemplary display interface of a computing device of the collaborative system in accordance with one embodiment of the present invention.

FIG. 3 is an exemplary group display interface of the computing device of the collaborative system at a point in time during a collaboration session.

FIG. 4 is an exemplary group display interface of the computing device of the collaborative system after the collaboration session has been successfully completed.

FIG. 5 is an example display interface of the computing device of a virtual lobby interface.

FIG. 6 is a flowchart diagram of an exemplary suggestion mode process of the real-time collaborative system.

FIG. 7 is an exemplary display interface of the computing device of the collaborative system during a first point in the suggestion mode process.

FIG. 8 is an exemplary display interface of the computing device of the collaborative system during a second point in the suggestion mode process.

FIG. 9 is a flowchart diagram of an exemplary iterative suggestion selection process of the real-time collaborative system.

FIG. 10 is an exemplary display interface of the computing device of the collaborative system during an initial phase of the iterative suggestion selection process.

FIG. 11 is an exemplary display interface and suggestion list during a first round of the iterative suggestion selection process.

FIG. 12 is an exemplary display interface and suggestion list during a second round of the iterative suggestion selection process.

FIG. 13 is an exemplary display interface and suggestion list during a final round of the iterative suggestion selection process.

FIG. 14 is a flowchart diagram of an exemplary iterative suggestion selection process in another embodiment of the real-time collaborative system.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

As referred to in this specification, “media items” refers to video, audio, streaming and any combination thereof. In addition, the audio subsystem is envisioned to optionally include features such as graphic equalization, volume, balance, fading, base and treble controls, surround sound emulation, and noise reduction. One skilled in the relevant art will appreciate that the above cited list of file formats is not intended to be all inclusive.

Real-time occurrences as referenced herein are those that are substantially current within the context of human perception and reaction.

Prior systems for supporting networked collaboration have been developed, but are asynchronous in nature, letting users provide isolated input, sequentially, the results generated by simple votes, ratings, and/or polling. For example, the present inventor was awarded U.S. Pat. No. 8,745,104 entitled “Collaborative Rejection of Media for Physical Establishments” that describes a novel system for allowing groups of users to reject the media playing in a restaurant or other public venue through sequential polling. While effective for its desired purpose, such systems do not foster a true collaborative intelligence among groups of users. One reason that traditional polls and surveys fail to facilitate collaborative intelligence is that there is no real-time negotiation, users instead imparting “fire and forget” votes or ratings such that collaborators can't explore the options in real-time and converge on common ground. Even worse, the asynchronous nature of polls and surveys, as used by tools such as Reddit®, Yelp®, and Digg® cause distorted results. This is because the first few individuals to give a vote or rating have a disproportionate impact on the final output. The process is called “herding” or “snowballing” and reflects the fact that voters in asynchronous rating systems are deeply influenced by the votes that precede their own. In a recent study performed by researchers at MIT and Hebrew University of Jerusalem (Muchnik et al.; Science Vol. 341, Aug. 9, 2013), it was found that a single up-vote inserted as the first response on a forum like Reddit, can boost the likelihood of future positive ratings by an average of 32% and can distort the outcome by 25%. The researchers warn that these herding effects are distorting our perceived views on everything from product recommendations on Amazon to electoral polling and market predictions.

To avoid the pitfalls of asynchronous polling and enable a true real-time collaborative intelligence, we must advance the methods of computer mediated collaboration from the collection of isolated and sequential asynchronous input to more sophisticated closed-loop systems that engender real-time synchronous collaboration. What is further needed are methods for hosting, moderating, coordinating, and implementing real-time “swarms” of networked users wherein a plurality of users collaboratively provide simultaneous input that is processed by computer moderated means into collective intelligence with a unique and distinct group-wise will. Furthermore, innovative systems and methods are needed for enabling large groups of distributed users to make collaborative decisions in real-time, said decisions involving a multi-step process in which (a) a plurality of users provide a plurality of suggestions through a substantially parallel, substantially real-time process, and (b) the plurality of suggestions are evaluated by the collaborative swarm real-time through an iterative computer-moderated process such that one of the plurality of creative suggestions is selected by the closed-loop collaborative intelligence through the computer moderated execution of plurality of discrete rounds of collaborative decision making. This iterative process allows for a larger number of creative suggestions to be fielded from the group than can be presented and evaluated by the group at any one round.

The inventive systems and methods that enable a real-time, synchronous, Collaborative Intelligence that can generate and select from among a plurality of suggestions through a computer-moderated multi-round iterative process. The present invention builds upon methods and systems disclosed in prior co-pending applications by the present inventor and hereby incorporated by reference.

As described in related patent application Ser. Nos. 14/668,970, 14/708,038, 14/738,768, 14/859,035, 14/920,819 and 14/925,837 the massive connectivity provided by the Internet is used to create a real-time closed-loop collaborative consciousness (or emergent group-wise intelligence) by collecting real-time input from large numbers of people through a novel user interface and processing the collected input from that large number of users into a singular group intent that can collectively answer questions, make statements, take actions, select functions, or otherwise respond to prompts in real time. The methods use intervening software and hardware to moderate the process, closing the loop around the disparate input from each of the many individual participants and the singular output of the group.

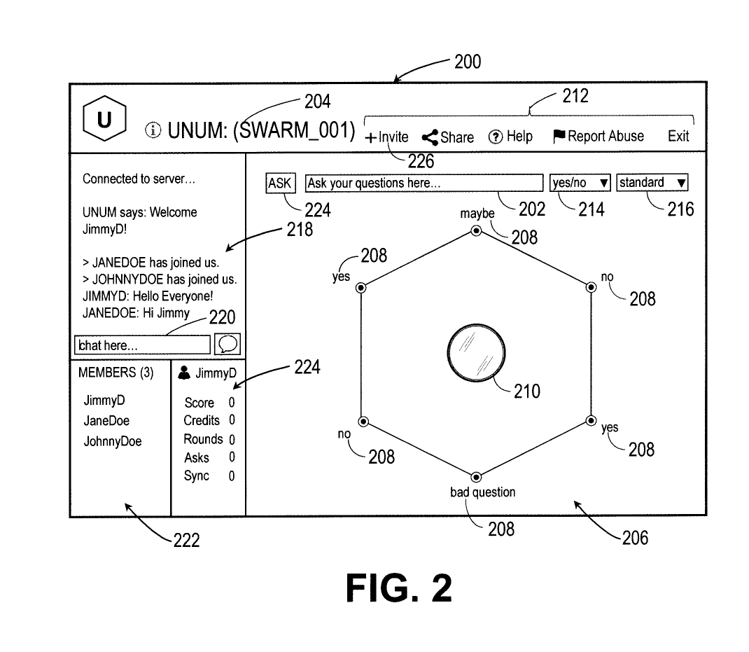

A collaboration system has been developed that allows the group of users to collaboratively control a graphical pointer 210 (as shown below in FIG. 2, also referred to as a puck) in order to collaboratively answer questions or otherwise respond to prompts. In one embodiment, each individual user (“participant”) engages the user interface on a computing device 104, conveying his or her individual real-time will in response to a prompt such as a textually displayed (or audibly displayed) question as well as in response to real-time feedback provided to the user of the group's emerging real-time intent. This closes the loop around each user, for he is conveying individual intent while also reacting to the group's emerging intent. Thus each user must be able to see not only the prompt that begins a session, but the real-time group intent as it is forming. For example, if the intent is being conveyed as words, the user will see those words form, letter by letter. If the intent is being conveyed as a direction, the user sees the direction form, degree by degree. If the intent is being conveyed as a choice among objects, the user sees the graphical pointer 210 get closer and closer to a particular chosen object. Thus, the user is seeing the group's will emerge before his eyes, reacting to that will in real-time, and thus contributing to it. This closes the loop, not just around one user, but around all users who have a similar experience on their own individual computing device 104 at substantially the same time. While the embodiments described generally refer to portable computing devices, it will be understood that non-portable computing devices, such as desktop computers, may also be used.

Using the disclosed systems and methods, a “social swarming” platform is enabled that allows users to join one of a plurality of hosted groups (also referred to as swarms), each group comprising a plurality of users. The user may collaborate with that group, earn scores and/or credits and/or rankings based on his performance with respect to others in the group, and browse the stored output from other groups. In some embodiments, groups can compete with other groups, each of said groups also earning group scores, credits, and/or rankings with respect to other groups.

As described in co-pending U.S. patent application Ser. No. 14/668,970 entitled METHODS AND SYSTEMS FOR REAL-TIME CLOSED-LOOP COLLABORATIVE INTELLIGENCE, by the present inventor, which is hereby incorporated by reference, systems and methods have been developed that allows a group of users to collaboratively control the motion of the graphical pointer 210 through a unique group-wise control paradigm. In some embodiments, the collaboratively controlled pointer 210 is configured to allow a group of users to choose letters, words, and/or numbers in response to a prompt posed to the group. This enables the formation a group response that's not based on the will of any individual user, but rather based on the collective will of the group. In some embodiments, the group response comprises a set of letters, numbers, and/or words that form a textual reply to a question or statement posed to the group. In this way, the system disclosed herein enables a group of people to verbally communicate as a single collective intelligence. In some embodiments, the group response may comprise a task performed in response to a prompt, for example the collaborative control of the pointer 210 to draw a picture as a group. We refer to such a collective intelligence herein as a “swarm A.I.” for it's an artificial intellect that emerges from the group as a result of unique computer-moderated methods employed herein.

As described in co-pending U.S. patent application Ser. No. 14/708,038 entitled MULTI-GROUP METHODS AND SYSTEMS FOR REAL-TIME MULTI-TIER COLLABORATIVE INTELLIGENCE by the current inventor, which is hereby incorporated by reference, additional systems and methods were disclosed that encourage groups of real-time users who are collaboratively answering questions by controlling the pointer 210 , to produce coherent responses while discouraging incoherent responses. A number of methods were disclosed therein, including (a) coherence Scoring, (b) coherence feedback, and (c) tiered processing. These and other techniques greatly enhance the effectiveness of group-wise collaborative control, incentivizing participants to convey their individual will in a more collaborative and coherent manner. By promoting greater collaboration among members of a real-time group, the result a more focused “swarm intelligence” that produces more coherent answers in shorter amounts of time.

As described in co-pending patent application Ser. No. 14/738,768, entitled INTUITIVE INTERFACES FOR REAL-TIME COLLABORATIVE INTELLIGENCE, by the current inventor, which is hereby incorporated by reference, systems and additional novel methods were disclosed that provide additional novel systems and methods for user interfacing that make group-wise collaborative control more intuitive for the participating users. More specifically, novel systems and methods were disclosed that enable individual users to intuitively impart their own personal intent upon the graphical pointer 210 that's being collaboratively controlled through real-time synchronous input collected from a plurality of users. Some disclosed embodiments support users interfacing with a mouse, touchpad, trackball, or touchscreen. Other embodiments support users interfacing by tilting a mobile computing device such as a phone or tablet. Some preferred methods employ a manipulatable graphical magnet such that each user positions the magnet so as to impart a simulated pull on the group-wise pointer 210. The sum (or average) of the plurality of user's individual pulls are then used to influence the group-wise motion of the pointer 210, thus providing a physically intuitive control paradigm. This and other novel solutions disclosed therein, solved the unique problems posed by enabling real-time synchronous collaborative control of the group-wise pointer 210, thus enabling more effective “swarm intelligence” systems.

Also disclosed were methods and systems to enable individual users to quickly and easily pose questions to a collaborating group. As described in the co-pending applications, moderating software can be configured to orchestrate which users can ask questions to the group and when. Once a question is asked, it can be answered through collaborative control methods in which the pointer 210 is enabled to select one of a predefined set of answer choices 208 (also referred to as input choices) displayed (such as YES, NO, MAYBE, PROBABLY, DOUBTFUL) and/or by selecting one of a set of alphanumeric characters. While such methods are highly effective, additional methods were disclosed herein that also allows individuals to specify a set of custom choices (i.e. possible answers) when asking a question to the group. The custom choices are then displayed graphically to the group as spatially arranged elements. The users can then collaboratively select among the spatially arranged elements using the group-wise pointer 210. This allows for “bounded-set questions” to be asked in a fast and fun manner, making the overall user experience far more enjoyable and efficient. This and other question-asking methods will be described in detail later in this document.

Also disclosed were innovative hosting methods, allowing large numbers of users to login and participate in collaborative experiences. More specifically, a novel paradigm was disclosed that allows groups of users to enter one of a plurality of on online collaboration groups (referred to herein as swarms) and participate in question/answer sessions. Users can choose among the plurality of swarms, some being public (for groups of strangers), other being private (for groups of friends). The swarms can be general or themed, such that themed swarms are for questions on a particular topic. In some embodiments, swarms can compete with other swarms, bringing the real-time synchronous methods disclosed herein to a higher order, creating a group comprised of groups (i.e. a swarm of swarms). Also disclosed were methods of giving swarms their own unique voice by enabling answers produced by synchronous groups of users to be Tweeted° (via Twitter®). This technology is the first known deployment of Tweets from a consciousness comprised not of a single individual, but a swarm of individuals acting as emergent artificial intelligence.

As described in co-pending U.S. patent application Ser. No. 14/859,035, entitled SYSTEMS AND METHODS FOR ASSESSMENT AND OPTIMIZATION OF REAL-TIME COLLABORATIVE INTELLIGENCE SYSTEMS by the present inventor, and hereby incorporated by reference, a system and methods have been developed for enabling swarms of users to modify its configuration dynamically over time, optimizing the performance of the swarm intelligence by altering its population and/or the connection strength of members of that population. In some such embodiments the members of a swarm can selectively eject (i.e. banish) one or more low performing member of that swarm (from the swarm), using the group-wise collaborative decision-making techniques herein. In many such embodiments, “low performance” is determined by assessing a novel “synchrony value” (also referred to as “synchronicity value”, “sync value”, of “sync score”) for that user. If the sync value is below a certain threshold, the software poses a question to the group—asking for a collaborative decision as to whether the user should be banished from the swarm or not. If the group collectively agrees to eject a member, that member is ejected, no longer participating in the group-wise control of the graphical elements displayed. In some embodiments, the decision is binary (banish or not banish) in other embodiments, the group can be provided with other options, such as putting the low-performing member on “probation”. If the user continues to perform poorly (with low sync values) during his or her probation period, he could be (a) automatically banished, or (b) banished upon another collaborative decision put to the members of the group. In some such embodiments an ejection threshold value is set by users such that if the sync value of an existing member (averaged across some number of prior trials) falls below the ejection threshold, that user is either (a) automatically banished, or (b) selectively banished based on real-time collaborative input from the swarm.

In other embodiments, a swarm can be configured by users to have a selectable entry threshold which governs a minimum sync value for users to join the swarm. In this way, a user's historical performance (over some prior number of answers, as executed within any number of existing swarms) can be used to govern entry into a particular swarm. This allows users to customize the swarm, indicating how “collaborative” a person needs to have been (historically) in order to join the swarm. A highly collaborative user, as indicated by his currently high sync value (for prior trials), may be allowed into a swarm because his or her sync value is above the selected threshold, while a highly “obstructionist” user, as indicated by his currently low sync value (for prior trials), may not be granted entry into the swarm. The entry governance process is moderated by the underlying software. In some instances, a user with a sync value that is in a middle range may be presented to the group within the swarm by the moderating software—the question posed, “Should user A with sync value X be allowed into the swarm?” The current members of the swarm can then collectively decide using the collaborative control methods disclosed in co-pending applications, if the user is to be allowed into the swarm or not.

In some embodiments, ejection of members is not based upon a specific threshold, but rather based upon a periodic “purging algorithm” in which the lowest performing member or members of the swarm are either (a) automatically banished, or (b) selectively banished based on a collaborative decision from the swarm. In some such embodiments the purging algorithm runs at a regular time interval, and identifies either (a) the lowest performing (i.e. least collaborative) member of the swarm for potential ejection, or (b) the members of the swarm who comprise the lowest 10% of performance in their sync value (i.e. least collaborative). In some such embodiments, the users of a swarm don't know if they fall within the lowest 10% and yet they are asked to collaboratively decide if the lowest 10% should be ejected from the swarm. This puts members in a unique position of helping to make a decision that could result in their own ejection. This forces members to carefully consider the decision and not just reflectively eject members. In some embodiments, the “purging algorithm” is not triggered at time intervals, but rather triggers as a result of the overall swarm performance (as measured by a group synchronicity value) falls below a particular level. Because the group synchronicity value is a measure of how well the group is working as a collaborative unit, if the group is not behaving above a minimum collaborative level, one or more members may be purged. This is a highly effective method because it leaves high-performing swarms intact, but purges the obstructionist members of low performing swarms.

As also disclosed, swarms can be configured to dynamically adjust its own configuration, not by ejecting members of the swarm but by adjusting the relative weighting of the input received from members of the swarm. More specifically, in some embodiments, algorithms are used to increase the impact (weighting) that some users have upon the collective pull of the pointer 210, while decreasing the impact (weighting that other users have upon the collective pull of the pointer 210. More specifically, user sync values are computed to reflect each user's contribution to (or resistance of) an emerging consensus in each trial. Users who show a time history of high synchronicity, have their weighting values increased by the underlying software, while users who show a time history of low synchronicity have their weighting values decrease. In this way, the swarm intelligence is adapted over time by the underlying algorithms disclosed herein, strengthening the connections (i.e. input) with respect to the more collaborative users, and weakening the connections with respect to the less collaborative users. In this way, the collaborative swarm in controlled in a manner innovatively reminiscent of an adaptable neural network that optimizes its intelligence over time

In some embodiments of the present invention, a user can request entry into one swarm, that entry being granted dependent upon a question automatically posed to the current members of the swarm by the underlying software, the question then being answered through collaborative real-time control. More specifically, the user can request entry to the swarm by clicking on that swarm in a directory of current swarms referred to herein as the virtual lobby. The members of that swarm are alerted to this request by an automatic question that appears. If the member's user name was JohnnyDoe, the question might appear as follows—“JonnyDoe has requested entry to the swarm. Should we grant him access?” The group then answers the question through collaborative control, selectively granting access, not as a decision by any individual but by the collective swarm intelligence. In some instances, stats about the requesting user are also displayed to the group including that users score, rank, and/or sync value.

What was still needed, however, to enable enhanced collaborative experiences, were novel methods that do more than collect a single request from a single user (such as the request entry) to trigger the collaborative decision by the swarm of real-time synchronous users.

As disclosed in co-pending U.S. patent application Ser. No. 14/920,819, entitled SYSTEMS AND METHODS FOR ASSESSMENT AND OPTIMIZATION OF REAL-TIME COLLABORATIVE INTELLIGENCE SYSTEMS by the present inventor, and hereby incorporated by reference, systems and methods have been developed for enabling a member of a swarm to ask a question to the group and then collect suggestions populate the possible answers from other members of the swarm. The group then collectively selects from among the options submitted by collaboratively moving the graphical pointer 210 by synchronous real-time control. To enable such a feature across a distributed network, a variety of innovative methods and systems have been developed. This technique is referred to herein as “suggestion mode” wherein the user who asks a question or otherwise triggers a prompt, also indicates by selecting suggestion mode that a set of suggested solutions to that question (or other prompt) are to be collected from a plurality of other members of the swarm.

When a suggestion mode question is asked by one member of the swarm, all other members of the swarm are alerted with a pop-up window that asks them for suggestions. A “suggestion timer” is optionally employed, giving the group a fixed time-window to provide suggestions, for example, 30 seconds. The system may be configured such that if a minimum of 2 suggestions are not contributed within the 30 second window, the question is terminated. That's because a minimum of two choices are needed or the swarm has nothing to choose between. Conversely, if a full set of suggestions is received before the 30 second time limit is up, the question immediately begins, the group moving the puck 210 to choose among the suggestions that populated the board. In the event that more suggestions are made than fit on a target area display, the first suggestions received from users are used by the software. Conversely, users with higher scores, ratings, sync values, or credit values, may be assigned priority making suggestions. In some embodiments, especially those with very large numbers of users in the swarm, a randomization process (i.e. lottery) is used to select among large numbers of received suggestions when populating the target area 206 with suggestions for the swarm to choose among.

This method is highly effective, for it allows the swarm to engage in a multi-step question and answer process that combines the benefits of asynchronous and synchronous interactions among groups. For example, a swarm might comprise of a small group of friends. One user asks the group a question, entering it into a question box—“What movie should we see tonight?” The user selects suggestion mode. Immediately, that question appears on the screens of all the other users. Also appearing on their screens is a suggestion dialog box, asking them to provide suggestions and giving the time limit (for example, 30 seconds, counting down with a timer). As the remotely networked users enter suggestions, they appear around the target board on all their screens (substantially simultaneously). In addition, a chat window 218 indicates the name of the user who made each suggestion. When the time is up, or when a full set of suggestions are received, the software starts the answer phase of the session, giving the users collaborative control over the pointer 210 (or “puck”). The users then engage in real-time synchronous control, collaboratively moving the pointer 210 to one of the choices. That choice (the answer) is then sent to all members, appearing on their remote screens. In this way, a group of friends can rapidly and definitively decide what movie to go see, converging upon an answer in 90 seconds or less. In this example, the 90 seconds comprises a maximum of 30 seconds to collect suggestions, and then 60 seconds to pick a choice that satisfies the collaborative will of the particular group. It's fun for users and effective.

While the prior systems aforementioned enable the collection of real-time suggestions from a plurality of users in a computer-moderated collaborative intelligence, they are not optimized for collecting large numbers of suggestions from users. That's because it's difficult for any one individual to make a rapid decision among a large number of options for just reading and evaluating the options takes time. This can be cumbersome (or even dull) for users who want to engage in a real-time fun experience. To address this need, inventive methods have been disclosed by the present inventor which enable users to process suggestions in parallel by splitting the task among sub-groups. As described in co-pending U.S. patent application Ser. No. 14/925,837, entitled MULTI-PHASE MULTI-GROUP SELECTION METHODS FOR REAL-TIME COLLABORATIVE INTELLIGENCE SYSTEMS by the current inventor, which is hereby incorporated by reference, systems and additional novel methods were disclosed that support parallel processing of suggestions which is an ideal approach for collaborative groups (i.e. swarms) comprising hundreds, or thousands, or even millions, for such groups could generate massive numbers of suggestions in a very short amount of time. The parallel processing approach is amazingly effective, allowing for tens of thousands of suggestions to be processed by the collaborative group in just minutes, yielding a single solution.

The parallel processing approach requires a highly sophisticated computational architecture that can create and merge collaborative sub-groups on the fly. While this is justified for supporting massive numbers of suggestions, for mid-sized swarms that generate on the order of dozens of suggestions, the approach adds architectural complexity that may not be needed. Instead what is needed is a computer-moderated approach that enables dozens of suggestions to be presented and evaluated in a short amount of time, without resorting to a computational complexity that adds processing burden, hosting burden, and overhead burden. For these mid-size groups, an ideal approach has been developed in which a single swarm operates in an iterative decision-making process such that a subset of the full set of suggestions is evaluated first, a preferred choice is selected, which is then presented along with another subset of the full set of suggestions. This iterative process is repeated until the full set of suggestions is evaluated by the group.

As disclosed herein, innovative methods and systems are described that enable the creation and moderation of a real-time collaborative intelligence by enabling through networked computer-moderation, a plurality of users to form a real-time closed-loop system for generating and evaluating a plurality of user-suggested creative ideas through synchronous collaboration, said closed loop system enabling the identification of one said user-suggested ideas as the preferred choice of the group from among the plurality of suggestions.

The system enables through networked computer-moderation, the plurality of users to each receive a real time prompt about a question, decision, notion, or action to be decided upon by the synchronous closed-loop collaborative real-time system (i.e. swarm). The prompt may be posed by a single member of the synchronous swarm. The prompt may be crafted by the swarm itself through a prior synchronous intelligence process. The prompt may come from another swarm, enabling to artificial collaborative intelligences to communicate/debate. Or the prompt may come from an individual outside of the swarm, for example an individual seeking guidance from the large collaborative intelligence. In some embodiments a designated moderator could impart the prompt.

The system enables, through networked computer-moderation, the plurality of users to provide a plurality of suggestions to a computing system through a substantially parallel, substantially real-time process, the plurality of suggestions being provided by said plurality of users through the substantially simultaneous display of said prompt to each of said users on the computing device 104 associated with each user. In some embodiments the time limit is provided for this synchronous input period, said time limit being for example 10 to 30 seconds. The present invention assumes the number of suggestions generated by the plurality of users during the input period is large enough that it would be cumbersome, difficult, boring, or otherwise non-advantageous for the group to choose among all of them in one answer session. Based on user testing, 5 to 10 suggestions can be handled by most users in a single response session, although 6 to 8 may be an ideal range.

The system enables, through networked computer-moderation, the plurality of users to collaboratively consider a set of suggestions that is more than would be advantageously considered in a single answer session through a computer-moderated iterative process. The process is such that a manageable subset of the full set of suggestions is presented to the group of users for selection through a first closed-loop synchronous decision process. The selected one of that subset remains, referred to herein as the first selection, and the other choices on the display screen are re-populated from the remaining set of full set of suggestions. The computer moderated system then provides a second closed-loop decision process in which the first selection of the first process is pitted against a plurality of suggestions from the remaining set of the full set of suggestions. The result is a second selection of the suggestion set, this being chosen from among the first selection and the set of repopulated suggestions. The second selection may be the same as the first selection if it was preferred by the synchronous group over the re-populated suggestions. Or, the second selection may be one of the repopulated suggestions. Either way, if there are still suggestions in the full set that have not yet been evaluated by the group, the iterative process repeats again for a third time, or as many additional times as is needed, until all the suggestions from the full set have been evaluated. The end result is a final selection of the full set of suggestions, the final selection being the most preferred of the set.

The system then enables, through networked computer-moderation, the final selection of the full set of suggestions to be communicated to the computing device 104 used by each of the plurality of users. Further, the user who suggested the final selection may optionally be identified by the software such that all users are informed by display on their computing devices 104 who suggested the final selection. In some embodiments, that user receives credit, points, or other recognition.

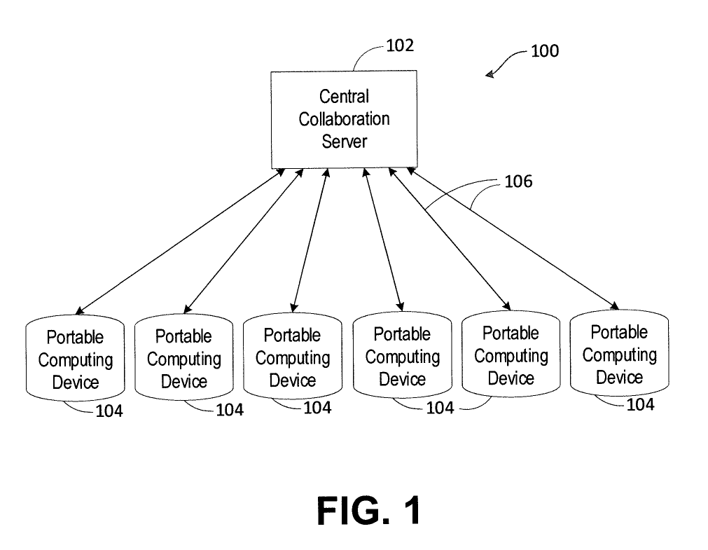

Referring first to FIG. 1, a schematic diagram of an exemplary collaboration system 100 is shown. Shown are a Central Collaboration Server (CCS) 102, the plurality of portable computing devices 104, and a plurality of exchanges of data with the Central Collaboration Server 106.

Embodiments of the plurality of portable computing devices 104 and the interaction of the computing devices 104 with the system 100 are previously disclosed in the related patent applications.

As shown in FIG. 1, the system 100 comprises the Central Collaboration Server (CCS) 102 in communication with the plurality of computing devices 104, each of said computing devices 104 running a Collaborative Intent Application (“CIA”). The system 100 is designed to enable the plurality of users, each engaging an interface of one of said computing devices 104, to jointly control a single graphical element, for example the movable pointer 210, through real-time group-wise collaboration. In some embodiments, such as a multi-tier architecture, the portable computing devices 104 may communicate with each other. The CCS 102 includes software and additional elements as necessary to perform the required functions. In this application, it will be understood that the term “CCS” may be used to refer to the software of the CCS 102 or other elements of the CCS 102 that are performing the given function.

Although multiple pointers controlled by multiple swarms is enabled by the innovations of the present invention, for the current discussion we will give examples that are confined to a single swarm. This is for simplicity of description and is not intended to limit the scope of the innovations.

Referring again to FIG. 1, each of the computing devices 104 comprises one or more processors capable of running the CIA routines and displaying a representation of the pointer 210 along with the plurality of graphical answer choices 208. The computing device 104 could be, for example, a personal computer running the CIA application. It could also be a mobile device such as a smart phone, tablet, headset, smart-watch, or other portable computing device running the CIA. The CIA software code can be configured as a stand-alone executable or be code that executes inside a web-browser or other shell.

While FIG. 1 shows only six computing devices 104 in communication with the CCS 102, the system 100 is highly scalable, enabling hundreds, thousands, or even millions of users to connect simultaneously to the CCS 102, each using their own computing device 104, thereby sharing a real-time collaborative experience with the other users. In this way, large numbers of users can collaboratively control the pointer 210 to generate a response by selecting letters, words, or numbers as a group intelligence.

While FIG. 1 shows simple top-down architecture for direct communication between the CCS 102 and each of the computing devices 104, related application Ser. No. 14/708,038 entitled MULTI-GROUP METHODS AND SYSTEMS FOR REAL-TIME MULTI-TIER COLLABORATIVE INTELLIGENCE discloses multi-group and tiered architectures that enable shared processing loads among large numbers of computing devices 104. While FIG. 1 shows a dedicated CCS 102, the system 100 can be configured such that one of the computing devices 104 acts as the CCS 102 by running both CCS routines and CIA routines. Such a model is generally viable only when the number of users is low. Regardless of the architecture used, each of said computing devices 104 that is engaged by a participating user includes one or more display devices for presenting a graphical user interface to the user.

Referring next to FIG. 2, an exemplary display interface 200 is shown in accordance with one embodiment of the present invention. Shown are a prompt bar 202, a group name 204, a target area 206, the plurality of answer choices 208, the pointer 210, a communication menu 212, a board selection drop-down menu 214, a physics selection drop-down menu 216, the chat window 218, a chat input box 220, a current member list 222, a statistics display 224, an invite button 226, and an ask button 228.

The graphical pointer 210 is simultaneously displayed to each user by the CIA running on his computing device 104. The pointer 210 displayed to each user appears in a substantially similar position with respect to the set of answer choices 208 (as compared to the position of the pointer 210 on other user's screens). The synchrony of the interfaces is coordinated by the data 106 received by each computing device 104 sent from the CCS 102 over the communications link. In a current embodiment, data 106 is sent from the CCS 102 to each of the plurality of computing devices 104 at a rate of 60 updates per second, the data 106 including the current position of the graphical pointer 210 (also referred to as a puck) with respect to the set of graphical answer choices 208, as further shown below.

In general, the answer choices 208 (also referred to as input choices) are identically displayed upon all the computing devices 104, although some unique embodiments allow for divergent answer choices 208. For example, in some embodiments the answer choices 208 are displayed in the native language of each user, each answer choice 208 conveying a substantially similar verbal message, but translated based on a language setting of the user. This feature enables swarms of individuals who may speak different languages and may be unable to communicate directly, to still form a swarm intelligence that can collaboratively answer questions or take actions. In such embodiments, the displayed questions are also automatically translated into the chosen native language of the user. This is also true of a displayed answer, and optionally the chat window 218 output.

In some embodiments, multiple graphical pointers 210 are displayed by the computing devices 104, each of said graphical pointers 210 being collaboratively controlled by a different group of users. For example, 500 users may be collaboratively controlling Graphical Pointer #1, while a different group of 500 users are collaboratively controlling Graphical Pointer #2. The first group of 500 users comprises a first swarm. The second group of 500 users comprises a second swarm. This unique system and methods allow for the first swarm to compete with the second swarm in a task that is displayed simultaneously to all 1000 users on each of their computing devices 104.

As shown in FIG. 2, the CIA software running on each computing device 104 is configured to display a graphical display interface 200 that includes at least one graphical pointer 210 and the plurality of spatially arranged graphical answer choices 208. In the example shown, the graphical pointer 210 is configured to look like a “glass puck” with a central viewing area that is transparent. In the example shown, the answer choices 208 are configured as a hexagon of six answer choices 208, each answer choice 208 including a graphical icon (in the embodiment shown, a dot inside a circle) and an associated word. In this case, the six answer choices 208 correspond with possible answers to questions: “Yes”, “Maybe”, “No”, “Yes”, “Bad Question”, and “No”. When the pointer 210 is positioned over one of the answer choices 208 such that the answer choice 208 is substantially within a centralized viewing area of the pointer 210 for more than a threshold amount of time, that answer choice 208 is selected as a target. In common embodiments the threshold amount of time is 3 to 5 seconds. In the current embodiment, the centralized viewing area appears as a graphical etching on the glass pointer 210, the etching remaining invisible until the pointer 210 approaches a target.

As shown in the exemplary embodiment of FIG. 2, the spatially arranged graphical answer choices 208 can comprise letters, numbers, words, and/or punctuation marks. The answer choices 208 could also comprise photographs. In this example, if the pointer 210 is positioned over one of the six targets for more than the threshold amount of time, that answer choice 208 is selected as the answer to a previously asked question.

To ask a question, the user enters the question into the prompt bar 202. Once entered, the user clicks the ask button 228, which sends the question from the CIA software of that particular user (running on his computing device 104) to the CCS 102. Because many users could ask questions, the CCS 102 acts as the gate keeper, deeming the first question received (when no question is currently in process) as the one that will be asked to the group. In the current embodiment, not all users are enabled to ask questions at any given time to avoid too much competition for asking. In some embodiments, credits are redeemable by the user for the right to ask the question. In some embodiments, the user must spend credits to ask the question, and can only ask if he has enough credits. In some embodiments, users earn credits based on points awarded for participation in a session. More credits are awarded to users who have high sync scores, less credits being awarded to users with low sync scores.

In addition to asking questions, users can select from a plurality of possible target areas by using the board selection drop-down menu 214. The currently selected target area 206 is for yes/no questions. Other target areas may include true/false questions, good/bad questions, and other sets of standardized answers. Also, a spelling board may be included where a full alphabet of answer choices 208 are displayed, allowing users to spell out answers (as shown in co-pending applications). The spelling board may also include numbers, punctuation, backspace, blank space, and other alphanumeric characters.

As disclosed in co-pending applications, custom boards can also be entered by selecting “custom” from the board selection drop-down menu 214. As will be disclosed further below, “suggestion mode” can also be selected for a given question through the board selection drop-down menu 214.

As also shown in FIG. 2, users can selectively use a physics mode from the physics selection drop-down menu 216. As shown, a standard physics mode has been selected, but users can choose ice mode where the pointer 210 slides around on the target area 206 as if it were frictionless ice. A gravity mode is configured to pull the pointer 210 back to a location substantially near a center of the answer choice set (i.e. center screen) as if by simulated gravity. In a heavy mode the pointer 210 has substantially higher mass than in standard mode and thus is harder for users to collectively move. In a barrier mode, a set of physical barriers block a direct path to the answer choices 208, forcing users to collaboratively guide the pointer 210 around barriers to reach the answer choices 208.

As also shown in FIG. 2, the display interface 200 includes the chat window 218 that allows users to exchange messages by typing in the chat input box 220. Also included is the list of current members who are part of the group and thus enabled to ask questions and collaboratively provide control over the pointer 210.

Because users enter this group display interface 200 from a lobby display interface where the user can choose from among a plurality of available groups or swarms, the name of the current group (swarm) is also displayed. In addition, users can invite their friends to this group by clicking on the invite button 226 includes in the communication menu 212. In the current embodiments, these invites can leverage existing social networks such as Facebook® friends and Twitter° followers. Also included in the interface of the current embodiment is the statistics display 224 that gives the user of this instance of the software (on this computing device 104) a listing of his personal statistics including his score, credits, synchronicity value, the number of rounds he has participated in, and the number of questions he has asked the swarm.

When an exemplary question is entered by one of the users in the group, the question is sent by the CIA on that user's computing device 104 to the CCS 102. If the CCS 102 software determines that the question is valid, the question is then sent to all the users in the group so that it appears substantially simultaneously on the display interface of each of the computing devices 104. In a current embodiment, the question appears in a large box at the top of the target area 206. Then a “3”-“2”-“1” countdown timer appears at the center of the target area 206, notifying users get ready for the collaborative answer process, or session, to begin. The display interface (having received instructions from the CCS 102) then displays a graphical “GO” and the users will then collaboratively control the motion of the pointer 210, guiding it towards whichever answer choice 208 best satisfies the collaborative will of the group as emergent from the real-time swarm intelligence.

Each answer session is generally limited in total time by the underlying software of the present system 100, for example giving the swarm 60 seconds to converge upon an answer through the collaborative motion of the pointer 210. This time pressure is deliberate, for it inspires users to employ their gut instincts and intuitions rather than overthinking the question.

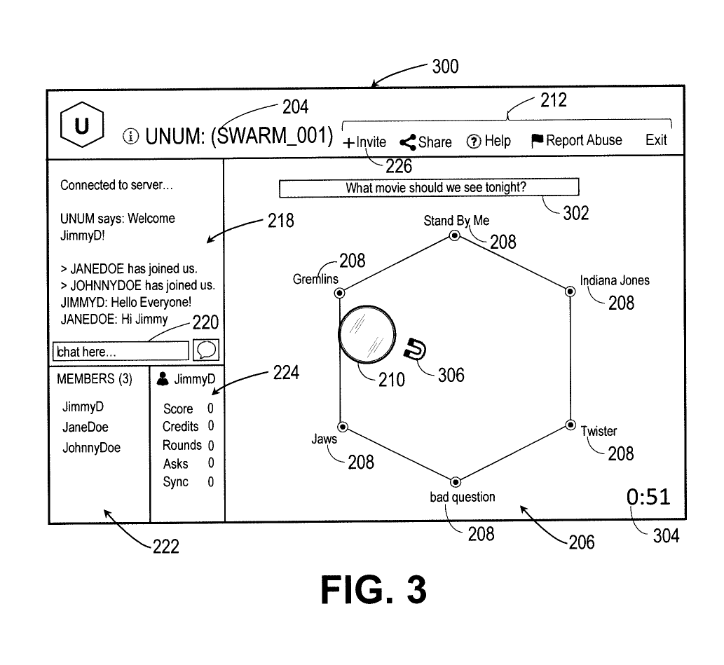

To support the use of time-pressure, the countdown clock 304 is displayed on a group display interface 300 of each user (as shown below in FIG. 3), the timing of the plurality of countdown clocks 304 coordinated by handshaking signals from the CCS 102. If the pointer 210 does not reach the target within the allotted 60 seconds, the system 100 determines that the collaboration is a failure, and sends a failure indication to the CIA of each computing device 104. In some embodiments, in response to receiving the failure indication the CIA terminating user input and displaying the words “brain freeze!” on the group interface. In addition, in response to receiving the failure indication all users could lose a number of points and/or credits for the collective failure of the group to guide the pointer 210 to a target.

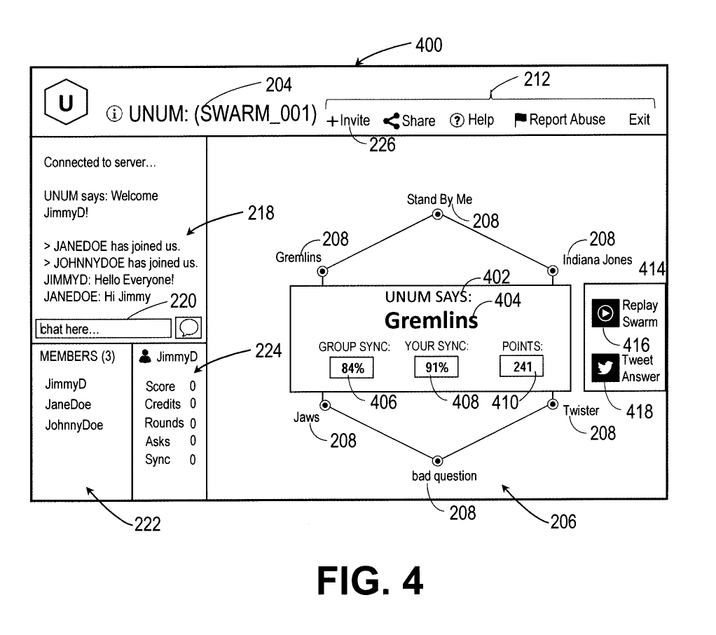

The system 100 is configured to determine that a target is achieved when the group successfully positions the pointer 210 over one answer choice 208 for more than the threshold period of time. When the group targets one answer choice 208, the target is displayed on the CIA screens of all the users as the answer to the question. Also displayed may be statistics for that answer as shown below in FIG. 4, such as the group cohesiveness score and the user synchronicity value, as previously described in related application Ser. No. 14/708,038. Also displayed may be points and/or credits awarded for the current user's participation in the emergent answer, as shown in FIG. 4.

Referring next to FIG. 3, shown is the exemplary group display interface 300 of one user at a point in time during a collaboration session, i.e. after the question has been received by the computing devices 104 but before the collaboration session has ended. Shown are the group name 204, the target area 206, the plurality of answer choices 208, the pointer 210, the communication menu 212, the chat window 218, the chat input box 220, the current member list 222, the statistics display 224, the invite button 226, a question display 302, a countdown clock 304, and a magnet icon 306.

As shown in FIG. 3, the basic layout of the display interface 300 is similar to FIG. 2. In FIG. 3, in the target area 206 the prompt bar 202, the ask button 228, the board selection drop-down menu 214, and the physics selection drop-down menu 216 have been replaced by the question display 302. The question display 302 appears substantially simultaneously upon the screens of the computers of all users in the swarm. Also displayed on the target area 206 are the set of answer choices 208 from which the users are being asked to collaboratively select from. In this case the question is—“What movie should we see tonight?” and the answer choices 208 include five movie names: “Jaws”, “Gremlins”, “Stand By Me”, “Indiana Jones”, and “Twister” along with a sixth answer choice 208, “Bad Question”. In many embodiments, the Bad Question choice is automatically included in the answer choices 208 by the CCS 102, allowing the swarm to collectively reject the question. This allows the group not to waste time on incoherent or undesirable questions.

After the question and answer choices 208 appear on the display interfaces of the group members, the “3”-“2”-“1” countdown timer appears (not shown) to signal the start of the current session. When the session begins, the users are now enabled to provide user input to the pointer 210, guiding it towards one of the answer choices 208. As the session time progresses, the 60 second countdown clock 304 counts down, applying time pressure to the group. In FIG. 3, the countdown clock 304 is shown at 0:51, indicating that 51 seconds remain in the current session. During the current session, group members may also be inputting messages via text using the chat window 218, and/or may be chatting with a simultaneously enabled group voice chat. This allows interpersonal communication during the session.

As disclosed in the co-pending applications which have been incorporated by reference, each user is enabled to apply forces upon the pointer 210 to convey his individual intent as to how the pointer 210 should move at any moment in time. The displayed motion of the pointer 210, however, is not a reflection of that user's individual input but a reflection of the collectively combined group input from the entire swarm of users. As disclosed in co-pending applications, the collective input from the plurality of users can be such that each user's input imparts an equally weighted contribution to the total force applied to the pointer 210. In some embodiments, weighting factors are used to give the input force from some users a higher contribution as compared to other users. As will be described later in this document, novel methods of adjusting the weighting factors have been developed such that computational configuration of swarms can be dynamically changed over time by the underlying software running on the CCS 102, optimizing the collaborative performance of a given group based on the historical performance of its members.

As disclosed in the co-pending applications which have been incorporated by reference, each user is enabled to apply forces upon the pointer 210 using one of a variety of innovative methods. In one preferred embodiment, disclosed in application Ser. No. 14/473,768, each user controls the graphical magnet icon 306 by manipulating a mouse, touchpad, touchscreen, tilt interface, or other provided user-interface method. In one such embodiment, as the user moves his mouse cursor within a threshold distance of the pointer 210, it turns into the magnet icon 306 that grows larger in size, the closer to the pointer 210 the mouse is positioned. The larger size indicates a larger force. The relative position of the magnet icon 306, which always orients itself towards a center of the pointer 210 under software control, indicates the direction of pull that user wants to impart on the pointer 210. In this way, a user can intuitively impart of force of a selectable magnitude and direction upon the pointer 210.

In other embodiments, the user can tilt the portable computing device 104 to convey a desired magnitude and direction. In such embodiments, the magnet icon 306 or other graphical indicator is displayed to indicate the imparted force. In some such embodiments, the user must also tap the screen while tilting the computing device 104, the frequency of the taps causing a higher force to be applied. This unique use of a combined tilt and tap methodology is highly effective, for it enables one handed input from users on small mobile devices. It also enables the ease of tilting, but avoids it feeling too passive by also requiring frequent tapping. In many such embodiments, the maximum force is applied for only a short time following each tap (for example 0.5 seconds) and then fades away over a subsequent period of time (for example 3 to 5 seconds). The displayed magnet icon 306 shrinks and fades away along with the force magnitude. This is a highly intuitive interface and requires that a user repeatedly tap to maintain a maximally applied force upon the pointer 210. This is an innovative implementation, for it has been found that requiring frequent tapping better engages the user in the collaborative experience when the tilt interface is used.

In other embodiments the user is enabled to swipe across a touchscreen display to indicate the magnitude and direction of the force the user desires to apply to the pointer 210. In many such embodiments the magnet icon 306 is displayed, indicative of the magnitude and direction conveyed by the swipe. In such embodiments, the swipe force is applied for only a short time (for example 0.5 seconds) and then fades away over a period of time (for example 3 to 5 seconds). The magnet shrinks and fades away along with the force magnitude. This is a highly intuitive interface and requires that the user repeatedly swipe the screen to maintain a maximally applied force upon the pointer 210. This is an innovative implementation, for requiring frequent and repeated swipes better engages the user in the collaborative experience when the swipe interface is used.

As disclosed in the co-pending applications, the CCS 102 software collects input from the plurality of users, computes a resultant motion of the pointer 210, and communicates the resultant motion of the pointer 210 to each CIA of the plurality of computing devices 104. The CCS 102 software also determines if the pointer 210 location is successfully targeting one answer choice 208 for more than the threshold amount of time. If so, the CCS 102 software determines that the question is answered and communicates the targeted answer choice 208 to all members of the group such that it is substantially simultaneously displayed upon the display interface of each computing device 104 included in the group.

In this way, the system 100 of the present invention enables groups of networked users to collaboratively control the graphical pointer 210 in response to one or more questions posed by members of group. More specifically, embodiments of the current system 100 enable each of the plurality of users to view on a screen of their own individual computing devices 104, a representation of the pointer 210 and the target area 206, and enable each of said users to convey the user intent (also referred to as the user intent value) as to the desired direction (and optionally magnitude) of motion that user wants the pointer 210 to move so as to select one of the answer choices 208 displayed on the target area 206. The user intent is represented as a user intent vector. The user intent vector can be conveyed by the user, for example, by tilting his computing device 104 in the desired direction, swiping the screen in a desired direction, or positioning the mouse such that the graphical magnet icon 306 pulls on the pointer 210 with a desired direction.

In some embodiments, eye tracking hardware and software are included in the computing device 104, for example the eye tracking hardware and software disclosed in U.S. Pat. No. 7,429,108 to the present inventor. The CIA is configured to operate the eye tracking hardware and software and receive input from the eye tracking hardware are software. In the current innovation, a user's gaze is tracked by the CIA and used to compute the user intent vector that represents the user's desired motion of the pointer 210, which is communicated to the CCS 102 software. More specifically, the user's gaze defines a location with respect to the pointer 210. The vector between the location and the center of the pointer 210 is then used by the CIA to compute the magnitude and direction of the user intent vector. In this way, the user can simply look towards a direction that he desires the pointer 210 to move, and the user intent vector is computed by the CIA and sent to the CCS 102 software by the CIA. In some instances the magnet icon 306 or other graphical element is displayed to represent the user intent vector on the display. In this way, the user can participate in the collaborative swarm intelligence experience using a hands-free method.

In some embodiments, a brain-computer interface (sometimes called a mind-machine interface, direct neural interface, synthetic telepathy interface, or a brain-machine interface), is employed to collect the user input of one or more users in the swarm. In some such embodiments, the user's brain-waves are detected by the brain-computer interface as he or she watches the pointer 210 move upon his screen. A calibration session is often required to correlate detected brain activity with a desired direction of motion of the pointer 210, but once that calibration is complete, the brain-computer interface system can be used by the CIA to compute the user intent vector that represents that user's desired motion of the pointer 210 at each time-step during the session, this user intent vector being communicated to the CCS 102 software. In this way, the user can simply think about a direction that he desires the pointer 210 to move, and the user intent vector is computed and sent to the CCS 102 software by the CIA. In some instances the magnet icon 306 or other graphical element is displayed to represent the user intent vector on the screen of the user's computing device 104. In this way, the user can participate in the collaborative swarm intelligence using a hands-free method.

Whatever the input method used (mouse, touchscreen, tilt, eye-tracking, or brain-tracking), the system 100 is configured such that the user intent vector is communicated by the CIA, running on the user's computing device 104, to the Central Collaboration (CCS) 102. The CCS 102 collects the user intent vectors from the plurality of users (via their separate computing devices 104), and then derives a group intent vector that represents the collective will of the group at that time. The group intent vector is then used to compute an updated location of the pointer 210 with respect to the target area 206 and the answer choices 208, the updated location reflecting the collective will of the group.

In many preferred embodiments, a physical model is employed in which the pointer 210 is assigned a simulated mass and damping, each user input represented as a simulated force vector. In some such embodiments, the mass and damping of the pointer 210 is adjusted dynamically by the software depending upon a physics mode selected by the user who asks each question by using the physics selection drop-down menu 216 shown in FIG. 2. In some such embodiments, the ice mode can be selected by the user in which the pointer 210 glides very freely as if on ice. In some such embodiments, the heavy mode can be selected by the user in which the pointer 210 requires the collaborative pull of a large majority of members of the swarm to achieve any real velocity. In some embodiments, the mass and damping are dynamically assigned by the software on the CCS 102 depending upon the current size of the swarm, the larger the swarm the higher the mass and higher the damping assigned.

Whether a physics model is used or not, the updated pointer 210 location is then sent by the CCS 102 to each of the computing devices 104 and is used by the CIA running on each of said computing devices 104 to update the displayed location of the pointer 210. In this way, the plurality of users can watch the pointer 210 move, not based on their own individual input, but based on the overall collective intent of the group.

As described in related U.S. patent application Ser. No. 14/668,970, the group intent vector can be computed from the plurality of user intent vectors as a simple average, or may be computed as a weighted average in which some users have more influence on the resulting collective group intent than other users. In such embodiments, the weighting of each user can be derived based on user scores and/or user synchronicity values (also referred to as synchrony values or performance values) earned during prior interactions with the system 100. In such embodiments, each user may be assigned one or more variables that represents how his or her input should be weighted with respect to other users in the swarm. In some embodiments the variable is called the user contribution index and is updated regularly to reflect the skill of that user in providing input that helps the group reach a coherent collaborative response. The user who demonstrates a history of “constructive input” (i.e. input that is supportive of the collective intent, will be assigned a higher user contribution index than the user who has demonstrated a history of “destructive input” (i.e. input that is substantially resistant to the collective intent). In this way, users are incentivized push for collaborative consensus.

Those users who are supportive to the emerging consensus are determined computationally by the CCS 102 by repeatedly comparing each user's user intent vector with the group intent vector. The more aligned that user's user intent vector is with the direction of the group intent vector, the more collaborative that user is behaving. The further the user intent vector is from the direction of the group intent vector, the less collaborative the user is behaving. This level of collaboration is represented by the value defined herein and in the related applications as the user's synchrony (or synchronicity). The synchronicity value may be an instant synchronicity value, i.e. one at a certain instant in time, or may be a session synchronicity value representing the overall user synchronicity for one or more sessions.

The synchronicity value for each individual user is determined by the CCS 102 by repeatedly comparing the user intent received from each computing device 104 (representing the user input reflecting the user's intent to move the graphical object of the pointer 210 in a given direction) with the group intent derived from all user intents. The synchronicity value of the individual user is determined but computing the difference between the user intent and the group intent. The synchronicity value may be an instant value, i.e., based on a single comparison of the user intent to the group intent at one point in time, or may be synchronicity value over a specific period of time, e.g. an average of the synchronicity values over that period. Thereby, the user synchronicity value each individual user represents at least in part that user's contribution to the collaborative control of the at least one graphical object.

In some embodiments, each individual's synchrony value ranges between an upper bound value and a lower bound value. In one embodiment, the synchronicity value ranges between +1 to −1, with the value +1 (the upper bound) being assigned when the user intent vector is substantially aligned with the group intent vector, and with the value of −1 (the lower bound) being assigned when the user intent vector is substantially in the opposite direction of the group intent vector, with all values between +1 and −1 being used to represent varying degrees of alignment. For example, if the user intent vector is 90 degrees out phase with the group intent vector, a value of 0 is assigned, for that is halfway between fully convergent and fully divergent. Thus, a skilled user is one who is able to convey his individual intent as input, but do so in a cooperative manner. Such a user will maintain a positive synchrony value during much of the session, for he or she is being supportive of the group intent. A user who maintains a positive value will be awarded more points and be assigned a higher user contribution index than a user who does not.

In some embodiments, the user's synchronicity values are computed as a percentage from 0% to 100%, for that is often an easier metric for users to understand. The session synchronicity value of 100% means the user has been perfectly in sync with the swarm. The session synchronicity value of 0% means the user has been entirely out of sync with the swarm. Session synchronicity values between 0% and 100% reflect relative synchronization with the swarm, with a 50% synchronicity value meaning the user was neutral with respect to the swarm. This is described in more detail later in this document.

In some embodiments, an average (or mean) synchronicity value is computed for the user over some number of prior questions. For example a “sync_5” synchronicity value can be computed as that user's average synchronicity value (also referred to as the average performance value) over the last five sessions. This is a highly useful value for it indicates how cooperative the user has been over a recent period of time. The “sync_5” synchronicity value can be used in combination with other time-histories, such as a “sync_50” synchronicity value which indicates the average synchronicity value for that user over the last 50 sessions, in order to compute that user's weighting value in the swarm. In some embodiments, the mean synchronicity value may be time-weighted such that time steps near the end of the session time period are more heavily weighted than time steps near the start of the time period.

In some embodiments, the CCS 102 determines at least one user assessment based at least in part upon one of more user synchronicity values. For examples, one assessment may be configured to determine whether the user is categorized as “flexible” or “entrenched”. In another example, one assessment may be configured to determine whether the user is “constructive” or “destructive”.

Referring next to FIG. 4, shown is an exemplary display interface 400 as displayed on the computing device 104 being used by one user of a group, shown at a moment in time after the group has successfully positioned the pointer 210 on one of the answer choices 208, selecting the answer choice 208 as the target, thereby collaboratively choosing the answer. Shown are the group name 204, the target area 206, the plurality of answer choices 208, the communication menu 212, the chat window 218, the chat input box 220, the current member list 222, the statistics display 224, the invite button 226, a prefix text 402, a target text 404, a group cohesiveness score indication 406, a session synchronicity value score indication 408, a points indication 410, an answer window 412, an answer options tab 414, a replay swarm icon 416, and a Tweet answer icon 418.

In this instance, the target is “Gremlins”, reflecting the swarm's collaborative will in response to the posed question: “What movie should we see tonight?” As shown in FIG. 4, the target is graphically displayed to each user on the screen of his or her computing device 104 (as controlled by the CIA software running on that device 104). In the embodiment shown, the graphical display includes the answer window 412 including the prefix text 402 “UNUM says:” along with the chosen target: “Gremlins”.

In some embodiments, the answer is also displayed in the chat window 218, as if communicated by the personified entity “UNUM” itself. This gives the swarm intelligence a feeling of personality and presence.

Also displayed in the answer window 412 is one or more statistics computed by the CCS 102 software. The statistics may reflect the performance of the group as a whole or reflect the performance of the particular user of that computing device 104. In this example, the group cohesiveness score indication 406, reflecting the synchronicity of the group, is shown of 84%, which indicates that the group was 84% aligned in their imparted motion of the pointer 210. The group cohesiveness score indication 406 includes the text “GROUP SYNC:” The group cohesiveness score of 84% shows strong convergence of group members, reflecting that the swarm intelligence spoke with high “conviction” when answering this question. A low group cohesiveness score would reflect a low conviction for the swarm intelligence. In some embodiments the group cohesiveness score may be repeatedly reported to and repeatedly displayed by each of the computing devices 104, for example during the session.

Related application Ser. No. 14/708,038 discloses some methods of computing the group cohesiveness score, such as to compute a running average of the absolute value (i.e. magnitude) of the group intent vector over time. The group cohesiveness score may have an upper bound and a lower bound, wherein a group cohesiveness score at the upper bound indicates that the plurality of real-time user intents are substantially aligned with each other, and a group cohesiveness score at the lower bound indicates that the plurality of real-time user intent values are substantially misaligned with each other. In one embodiment, the lower bound is essentially 0, as the summation of the user intent vectors, being opposite (exactly misaligned), cancel each other out.

In some embodiments, the CCS 102 determines at least one group assessment based at least in part upon one of more group cohesiveness scores. For examples, one assessment may be configured to determine whether the group is categorized as “flexible” or “entrenched”.

The group cohesiveness score may be repeatedly calculated by the CCS 102 during the session and repeatedly received by each of the portable computing devices 104.

In another embodiment, the real-time user intent values are determined to be substantially aligned with each other (i.e. at or near the upper bound) when their vector directions are substantially the same in at least a plane. The real-time user intent values are determined to be substantially misaligned with each other (i.e. at or near the lower bound) when a summation of their vector directions substantially cancel each other out, resulting in a near zero resultant.

Also displayed in the answer window 412 is the session synchronicity value score indication 408. The session user synchronicity value is a statistical indication of how well the particular user of this computing device 104 was aligned in his input with the swarm as a whole. The session synchronicity value score indication 408 includes the text “YOUR SYNC:” and value of 91%. In this case, the user was very highly aligned, achieving a 91% synchronicity value.

Also displayed in the answer window 412 is the points indication 410, indicating the number of points earned by this user as a result of his or her participation during the session. The user in this session has earned 241 points, as shown in the points indication 410. The points indication 410 also includes the text “POINTS:”

Users earn more points (or credits) as a result of being constructively collaborative, helping the swarm reach a meaningful consensus. Users earn less points (credits) as a result of being non-collaborative (obstructive), blocking the swarm from finding a meaningful consensus. In the case where the swarm cannot answer a question within the allotted time because consensus is never reached, all users lose points (credits). This innovative scoring method encourages participants to be collaborative rather than obstructionist, thereby improving the performance of the swarm intelligence. This imposes a philosophical situation often referred to as a Prisoner's Dilemma and structures it uniquely such that group collaboration and consensus trumps group stagnation and entrenchment. In this way, the present invention helps groups to find common ground.

Also displayed is the answer options tab 414 which gives users options related to the answer that was just reached by the swarm. The user can selectively Tweet® the answer by selecting the Tweet answer icon 418. This triggers a routine within the CIA that sends a Tweet request to the CCS 102 software, which then sends an automated Tweet to Twitter. The Tweet includes the question and the selected answer. The Tweet also includes a numerical indication of the number of users who participated in answering the given question, thus conveying the size of the swarm intelligence which produced this Tweet. The Tweet also includes a hashtag, for example “#UNUMsays”, as well as an indication of the group cohesiveness score. In this way, the swarm intelligence system comprised of dozens, hundreds, or even thousands of individual minds working as one can is given a unique voice as a social media entity. Enabling collaborative groups to ask questions, answer questions, and voice the swarm's collaborative intent over Twitter as a unique entity is highly unique and appealing to users. In some embodiments, the decision to Tweet an answer is posed by the software to the swarm. A question appears, e.g. “Should we tweet this?”, and a set of answers appear “yes”, “no”, etc. If the group picks “yes” or an equivalent, the swarm intelligence has decided to send its own Tweet. In this way, the invention described herein enables the formation of a swarm intelligence, enables that swarm intelligence to answer questions, enables that swarm intelligence to consider the answer that emerges and decide if that swarm intelligence wants to Tweet the answer publically.

As also included in the answer options tab 414, each individual user can select a replay swarm icon 416. Upon selection of the replay swarm icon 416, the session resulting in the current answer is replayed on the display. The session replay is unique in that it displays an indication of the input of all users in the group at the same time (i.e. the swarm input), giving insight into how the swarm converged upon the collective answer. The video of the swarm input is displayed in high speed (generally 2× to 5× the speed of the real session). This saves time while also conveying a more intuitive display of swarm activity, for the high speed motion of the swarm input indicates the central tendencies more effectively than a real-time display.

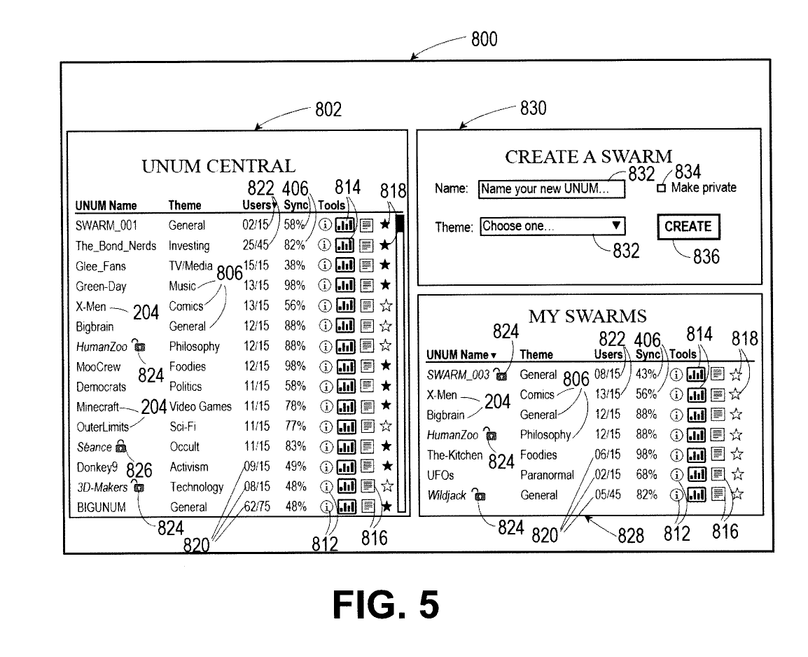

Referring next to FIG. 5, an example display interface of the virtual lobby interface 800 is shown.

Shown are a group directory 802, the plurality of group names 204, a plurality of group themes 806, a plurality of group cohesiveness score indications 406, a plurality of information icons 812, a plurality of statistics icons 814, a plurality of log icons 816, a plurality of favorites icons 818, a number of users in the group 820, a plurality of maximum number of users 822, a plurality of unlocked icons 824, a locked icon 826, a favorites section 828, a swarm creation section 830, a plurality of user input areas 832, a make private selection box 834, and a create button 836.

The virtual lobby interface 800 is accessible to computer users on computing devices 104 either through the CIA running on their computing device 104, or through a standard web browser (if the virtual lobby interface 800 is created as a standard html webpage). As shown in FIG. 5, the virtual lobby interface 800 includes the group directory 802 of available groups that users can join and then participate in real-time collaborative intelligence processes. The virtual lobby interface 800 is not real-time, but employs more traditional methods known to the art when joining chat rooms. The virtual lobby interface 800 is divided into a number of sections. One section is the group directory 802 labeled as “UNUM Central”. Using the group directory 802, users can browse the available groups, each of said groups being associated with a theme that governs the type of questions that users will ask.

The group directory 802 in the embodiment shown comprises a table, with a row for each group included in the directory. Information included in the row for each group includes the group name 204, the group theme 806, the current number of users in the group 820, the maximum number of users 822, and the current group cohesiveness score. The group theme 806 is a general description of the area of focus for the group, for example, investing, music, politics or technology.

If the group cohesiveness score is low, users may not want to enter that swarm because it means the group is not being highly collaborative. The low group cohesiveness score impacts the enjoyability of the session as well as limits the scores (credits) that users can earn.

Also included in the row for each group is a plurality of tool icons. Included in the tool icons of the exemplary lobby interface 800 of FIG. 5 are the information icon 812, the statistics icon 814, and the log icon 816. When the user selects the information icon 812 for one group, a display of additional information about that swarm is shown. When the user selects the statistics icon 814, a display of statistics of the group is shown. Statistics may include a number of questions asked by the group during one or more periods of time, an average number of users that participated in the group during one or more periods of time, and the average group cohesiveness of the group during one or more periods of time. The average group cohesiveness may be determined by finding the mean of a series of repeated group cohesiveness scores over a specific period of time. In some instances the mean is time-weighted such that time-steps near the end of the time period are more heavily weighted than time steps near the start of the time period. In some embodiments the period of time may comprise a plurality of completed question-and-answer sessions.

When the log icon 816 is selected by the user, a display of a log prior questions and answers of that swarm is displayed. The log display has been disclosed in the related applications. The log display may optionally include the ability not just to see the questions and answers, but also access the replay of those questions and answers. To achieve this, the CCS 102 archives not just a history of questions and answers for each swarm, but archives the replay data associated with each of said questions and answers. In some preferred embodiments, the replay data includes locative data for the pointer 210 and each of the magnet icons 306, said data stored at regular time intervals over the period of a response to a question. For example, pointer location coordinates along with magnet icon 306 positions, orientations, and size data may be stored every 0.25 seconds during the period of the response to the question. In addition, data related to the pointer 210 being over answer choices 208 may also be stored. In some preferred embodiments, magnet icon 306 data is stored relative to pointer 210 location, for example as a distance vector from the center of the pointer 210, the distance vector having a size and orientation relative to the center of the pointer 210.

The favorites icon 818 indicates which of the groups are included in a “favorites” list. In one embodiment the favorites list includes groups that user has selected as favorites, groups that have been created by the user, and private swarms that the user has been invited to. For the groups shown in the portion of the group directory 802 displayed in FIG. 5, the groups includes in the user's favorites are X-Men, Bigbrain, HumanZoo, OuterLimits, and 3D-Makers groups, as indicated by the highlighted (white) star icon. Groups not included in the user's favorites list are indicated by the unhighlighted (black) star icon.

Some groups displayed in the group directory 802 are configured to have limitations to group membership, as previously described. These groups are indicated by either the locked icon 826 or the unlocked icon 824 next to the group name 204. In the group directory 802 portion shown, the HumanZoo and 3D-Makers groups include the unlocked icon 824, indicating that it is currently possible to join those groups if the membership limitations are met. The Séance group includes the locked icon 826, indicating that it is not possible to join that group at this time.

The locked icon 826 may be displayed for one of a plurality of reasons, for example—the swarm may be locked because it is private and requires an invitation or password to be joined by the user. The swarm may be locked because it has an entry threshold such that users must have scores and/or statistics related to their historical performance that are above the entry threshold to be granted access. The swarm may be locked because the swarm is configured to require group approval for new users joining. The swarm may be locked because it has reached its real-time group size limit and thus cannot accept any additional users at the present time.

Also listed for each swarm is the information icon 812 which can take users to a page of additional information about that swarm, as well as a log of prior questions and answers. This log has been disclosed in co-pending applications. This log may optionally include the ability not just to see the questions and answers, but also access a replay of those questions and answers. To achieve this, the CCS 102 archives not just a history of questions and answers for each swarm, but archives the replay data associated with each of said questions and answers.

As also shown in FIG. 5, the swarm creation section 830 allows users to create their own swarm. By entering information into the user input areas 832 of the swarm creation section 830, and then selecting the create button 836, the user can define the name of a new swarm, give the new swarm a theme, and optionally make the new swarm a private swarm that requires a password, by selecting the make private selection box 834. In some embodiments, users are further given the ability to invite their friends to the new swarm by accessing their Facebook® friends and/or Twitter® followers.

As also shown in FIG. 5, the favorites section 828 of the display interface allows users to track swarms that are of particular interest to them. The favorites section 828 comprises a table including the swarms included in the user's favorites list. The favorites section 828 is formatted similarly to the group directory 802 table, including the UNUM name, theme, number of users in the group 820, maximum number of users 822, and icons 812, 814, 816, 818 for each swarm included in the favorites section 828. The favorites section 828 may also include the locked icon 826 or the unlocked icon 824 for the group, as applicable.

In this way, the present invention allows users to enter swarms, exit swarms, and create swarms. The historical performance for users (for example their score, credits, ranking, rating, and synchronicity values) are maintained by the CCS 102 for participation across all swarms. Thus a user can earn points by participating in a variety of swarms, public and private, although they can only be in one swarm at a time. That's because swarms require real-time participation.

In addition to defining the name, theme, and password of a given swarm, users are given the ability to configure new swarms by setting parameters that indicate: (a) whether the new swarm is private or public, (b) whether the new swarm supports adaptive weighting or all users should always have equal weighting, (c) whether the swarm supports automated purging or the purging of users should always be user initiated, (d) whether the swarm is supports “swarm admit only” or anyone can join the swarm without the swarm intellect making an assessment, (e) whether the swarm supports an entry threshold and if so, what level it should be, (f) whether the swarm supports an ejection threshold and if so, what the level should be. In addition, each swarm can be linked to one or more official Twitter® accounts, for the sending of Tweets that represent the official voice of that swarm intelligence.

To enhance collaborative experiences among real-time synchronous users over a distributed network, additional novel systems and methods have been developed for enabling members of a swarm to selectively ask a question to the group and then collect suggestions or representations of suggestions (also referred to as answer choice suggestions) from other members of that group which populate the possible answers displayed to the group. The group then collectively selects an answer from among the options submitted, using real-time synchronous control. To achieve such coordination across a distributed network, various systems and methods have been developed.

This technique is referred to herein as “suggestion mode”. Although uniquely powerful, it can be conceptualized as an enhanced version of the “custom mode” disclosed in co-pending patent application Ser. No. 14/738,768. In the custom mode, an individual user can ask a question and provide a custom set of answers that the swarm will choose from. In suggestion mode, the user asks a question, but then indicates that the custom choices are to be collected from a plurality of other members of the swarm. Under the coordination of the CCS 102 software, these suggestions then populate the displayed choices, through sophisticated coordination with the CIA software running on each computing device 104. To enable this, a novel series of steps are required.

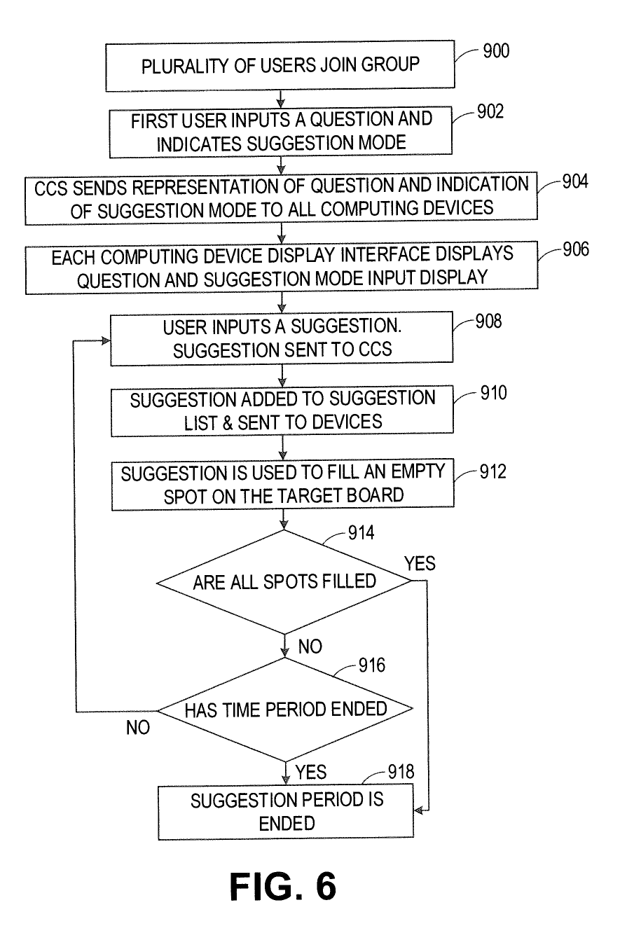

Referring next to FIG. 6, a flowchart diagram of a suggestion process of the real-time collaborative system 100 is shown. Shown are a first join group step 900, a user input question step 902, a send question to all devices step 904, a display question and suggestion mode step 906, a user inputs suggestion step 908, a CCS sends suggestion step 910, a fill target area step 912, a spots filled decision point 914, a time period decision point 916, and a suggestion period ended step 918.

In the first join group step 900, a plurality of users join one group (or “swarm”) at the same time, thereby comprising a specific real-time collaborative group of users. Joining the group can be achieved by each user accessing the lobby interface 800 through the CIA and selecting the specific group from the plurality of available groups. Alternatively, joining the group can be achieved by creating a new group using the swarm creation section 830 of the virtual lobby interface 800. Alternatively, joining the group can be achieved by responding affirmatively to an invitation from another user, either by email, over Facebook®, over Twitter®, over Google Hangouts®, or using some other social networking platform that links users. Upon joining the group, the CCS 102 sends a message to the CIA software running on the joining user's individual computing device 104, providing information related to joining that group, such as that user's current status data and/or group current status data. Also sent to the CIA software running on that user's computing device 104, is a list of user names of other current users who are participating in this real-time group.

Having joined the group, each user in the group is running the CIA on his own computing device 104 and is thereby provided with the display interface that enables them to simultaneously view the graphical pointer 210, said pointer 210 being substantially co-located across computing devices 104 as displayed with respect to the set of graphical answer choices 208. The answer choices 208 are also referred to as “answer choices”, as the users are choosing from the plurality of answer choices 208 to arrive at the answer, i.e. the plurality of answer choices 208 comprises the set of possible answers. Each user is also provided by the CIA with the prompt bar 202 by which they can enter a textual question to be asked to the group. Each user is also provided by the CIA software with the board selection drop-down menu 214 or other similar interface, by which they can select from among the set of standard target areas 206 to be associated with the asked question, each of said target areas 206 comprising the spatially arranged set of answer choices 208. The board selection drop-down menu 214 also allows users to choose a custom mode, wherein the user can enter a set of custom-defined answer choices 208. The board selection drop-down menu 214 also allows users to choose the suggestion mode to be associated with the current question, the suggestion mode being the one that is selected for the set of methods described herein.

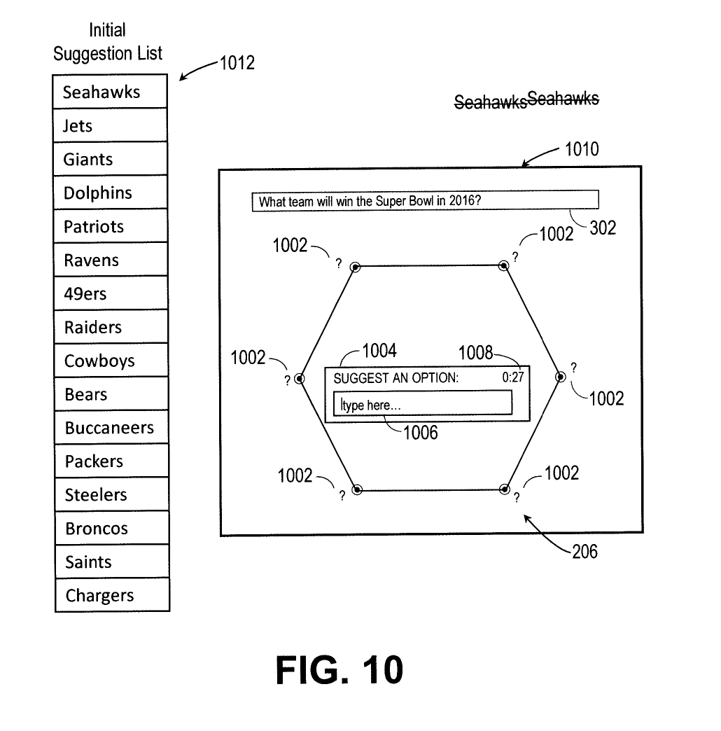

In the next user input question step 902, a first user types a question the prompt bar 202, selectively indicating to the CIA software that this question should be asked in suggestion mode, using the board selection drop-down menu 214 or other graphical or textual element, and then clicks the ask button 228 to input the question to the CIA. For example, the user might have joined a group of 10 friends, and asked “Where should we go for dinner tonight?” by entering it into the prompt bar 202, and indicated that it should be answered using the suggestion mode, by selecting that from the board selection drop-down menu 214. A similar display interface is shown below in FIG. 10. The process then proceeds to the send question to all devices step 904. In the send question to all devices step 904, the CIA sends a representation of the question (such as a text string) to the CCS 102, along with the identity of the associated user and an indication that the question is to be answered in suggestion mode. The CCS 102 then determines if the question is a valid question and whether the question has priority over other questions that may have been received from other users. If the question is valid and has priority, the CCS 102 determines that this will be the currently active question that is posed to the group. The CCS 102 then sends a representation of the question, along with an indication that it is to be answered using suggestion mode, to each of plurality of computing devices 104 associated with the plurality of users who comprise the group. For example, the CIA software might send the textual question “WHERE SHOULD WE GO FOR DINNER TONIGHT?” the computing devices 104 of 10 networked friends who comprise a current swarm, along with an indication that this question is to be answered using suggestion mode.

In the next display question and suggestion mode step 906, the CIA of each computing device 104, in response to receiving the representation of the question and the indication of suggestion mode from the CCS 102, updates the display interface to display the question and a graphical and/or textual indication that the question is to be answered in suggestion mode. For example, the CCS 102 might send the textual question “Where should we go for dinner tonight?” the computing devices 104 of 11 networked friends who comprise the current group, along with the indication that this question is to be answered using suggestion mode, whereby the display interfaces of the group are updated.

The CIA on each computing device 104 of the group executes the suggestion process where it (a) displays the received question, and (b) displays a suggestion dialog box 1004, indicating that suggestions are desired as possible answers to this new question. In many preferred embodiments, display of the question and the suggestion dialog box 1004 is coordinated to happen at substantially the same time upon the computing devices 104 of all plurality of members of the group. In this way, the members of the group are all informed at the same time that a new question has been asked and that suggestions are needed for possible answers. In many preferred embodiments, the suggestion process running on the CIA also presents a suggestion countdown timer 1008 (as shown below in FIG. 10) related to the suggestion request, giving all users a fixed amount of time to collectively enter suggestions. An indication triggering the suggestion countdown timer 1008 is sent from the CCS 102 to each computing device 104 in the group at the start of the suggestion period.

In some embodiments, the CIA software is configured to only allow one suggestion to be entered from each member of the group. In other embodiments, the CIA software is configured to allow users to enter multiple suggestions, one after another, using the suggestion box. In many preferred embodiments, the CIA software is configured to selectively enable both modes depending on either (a) a setting configured by the user who asked the question, or (b) a setting configured by the user who created the group. This setting may be “allow multiple suggestions from each user” and can be set as either yes or no. In an advanced version, the setting is controlled automatically by the CIA and/or CCS 102 software, depending upon the number of the users in a group. For groups that have less than a designated number of users, those users are allowed to provide multiple suggestions in response to a single question posed in suggestion mode. For groups that have more than a designated number of users, users are only allowed to provide one suggestion in response to a question posed in suggestion mode. This adaptive method is highly effective, for small groups often require multiple suggestion from users to keep the process moving quickly. In preferred embodiments, the suggestion countdown timer 1008 may be set to a short amount of time, such as 30 seconds.

In the next user inputs suggestion step 908, one user in the group types a suggestion into a suggestion input field 1006 of the suggestion dialog box 1004 and hits return. The CIA software running on the computing device 104 responsively sends a representation of the suggestion to the CCS 102, indicating the suggestion and a username of the user. It will be understood by those of ordinary skill in the art that multiple members of the group may input suggestions simultaneously.

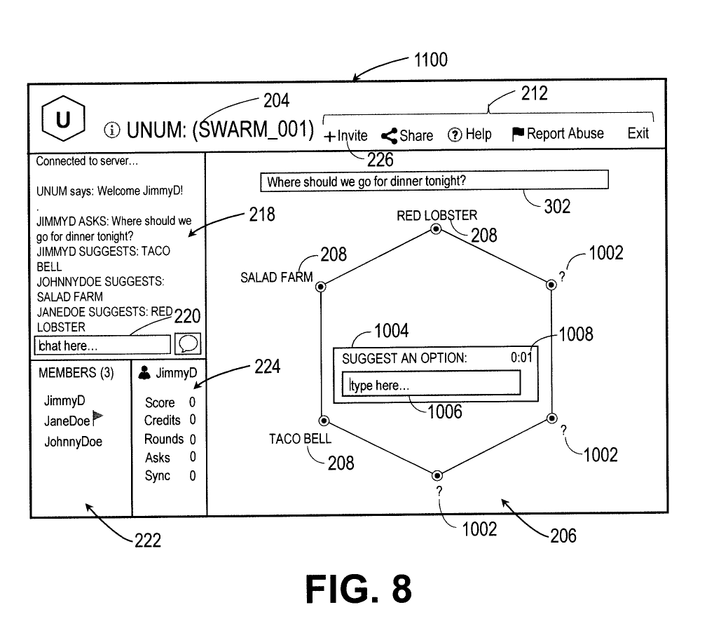

In one example, as shown in FIG. 8 below, the user of the computing device 104 shown in FIG. 8 might enter “Taco Bell” into the suggestion input field 1006 of the suggestion dialog box 1004. The suggestion “Taco Bell” along with the username of the user who made that suggestion, is sent from the local CIA software on the user's computing device 104 to the CCS 102, wherein the suggestion mode process is triggered. In this example, the username of that user is “JimmyD”.

In the next step, the CCS sends suggestion step 910, the CCS 102 adds the received suggestion to a set of answer choices 208 that will be used in responding to this question. The CCS 102 then sends an indication of the received suggestion (and optionally the username of the user who input the suggestion) to all of the computing devices 104 in the group. As shown in FIG. 8, the suggestion “Taco Bell” and an indication that it was made by user “JimmyD” is sent to all computing devices 104 in the group, substantially simultaneously. In preferred embodiments, this happens very quickly because all other users are currently contemplating their own suggestions.

In preferred embodiments, informing is done by graphically displaying the suggestion upon the target area 206. In preferred embodiments, as shown below in FIG. 8 the name of the user who made the suggestion is listed in the chat window 218, for example with text: “JimmyD suggests Taco Bell”. This is achieved by the CIA automatically composing a text phrase, using the user name and suggestion, and inserting the word “suggest”, allowing the CIA to communicate through natural language.

In the next fill target area step 912, an indication of the suggestion is sent to all computing devices 104, whereby the CIA changes one of a plurality of input choice placeholders 1002 (also referred to as answer choice placeholders) to the answer choice 208 equal to the suggestion. In some embodiments, in lieu of updating the target area 206 with the suggestion each time the CCS 102 receives one suggestion, the CCS 102 may select the answer choices 208 from the set of suggestions after all suggestions have been received. In some embodiments there is a criteria for using suggestions as answer choices, and a suggestion is not added to the set of answer choices 208 if the suggestion does not meet the criteria. In yet another embodiment, the set of answer choices 208 is ranked and the top answer choices 208 are included in the target area 206.

At the same time, the CCS 102 is likely receiving additional suggestions from other users, thus repeating the user inputs suggestion step 908, which then triggers a repetition of the CCS sends suggestion step 910 and the fill target area step 912. As described previously, in some embodiments, users are enabled to enter multiple suggestions, one after another, each of said suggestions triggering another instance of the user inputs suggestion step 908, the CCS sends suggestion step 910 and the fill target area step 912 . At the same time, the suggestion timer 625 counts down, telling all users how much time is left for suggestions to be collected.

The process then proceeds to the spots filled decision point 914.

During the spots filled decision point 914, if all input choice placeholders 1002 for answer choices 208 in the target area 206 have each been filled by one suggestion, the process proceeds to the time period decision point 916. If the designated time period has also ended, the process proceeds to the suggestion period ended step 918, suggestion period is over and the CIA updates the display interface to indicate that suggestions may no longer be input.

In many preferred embodiments, suggestion mode continues until either (a) suggestion countdown timer 1008 expires, or (b) all of the available input choice placeholders 1002 have been filled by suggestions from members of the swarm. Thus, if all users enter suggestions quickly, the suggestion phase of this question could be ended by the CCS 102 long before the suggestion countdown timer 1008 is up. To coordinate this, the CCS 102 sends out a suggestion set complete message to all the devices 104, when the CCS 102 determines that all the available responses have been filled by suggestions.

If all input choice placeholders 1002 on the target area 206 have not been replaced with answer choices 208, the process returns to the user inputs suggestion step 908, where the same user or another user inputs a new suggestion. The process then repeats until the time period ends or all positions are filled, in which case the process terminates at the suggestion period ended step 918.

In some cases, the suggestion time period expires before all the input choice placeholders 1002 are filled with answer choices 208. In many preferred embodiments, the CCS 102 software is configured to then execute the answer period of the session, leaving the blank spots empty. The CCS 102 software can then be configured not to allow users to collectively pick the input choice placeholder 1002.

If, however, fewer than 2 suggestions were received by the CCS 102 software by the time that the time period is ended, the question is deemed by the CCS 102 software not to be viable. This is because the group needs at least 2 answer choices 208 to choose between when answering a question. In such a situation, the CCS 102 software is configured to send a “not enough suggestions” message to each of the computing devices 104. The CIA software on those computing devices 104 then displays a “not enough suggestions” message, and terminates the session. In some embodiments, the users lose points (credits) for the failed attempt, because it was a non-collaborative result. In other embodiments, only the first user (the asker of the question) loses points, for his question failed to inspire a sufficient number of suggestions to proceed.

In response to the end of the suggestion period, the CIA software on each of the computing devices 104 may then start the answer period, as previously described in related applications. The end of the suggestion period may be indicated by hiding the suggestion dialog box 1004, and by enabling the collaborative control of the pointer 210. In some embodiments the CCS 102 sends a message to all computing devices 104 in the group. The message could be a simple trigger message, assuming that all devices 104 in the group already have received the question and the suggestions as they were entered. In some preferred embodiments, this message actually re-sends the question and the set of suggestions, to be sure that none of the computing devices 104 missed some data. Further, this allows for computing devices 104 who joined the group during the suggestion period to be brought up to date as to the current question, and the final set of suggestions.

It should be noted that some advanced versions of the CCS 102 algorithms handle suggestions in a manner which is not simply first-come first-serve, as described above. These methods are used for very large groups where far more suggestions are received than can fill the target area 206. One such method uses a randomization process to select a suggestion set from a large number of suggestions received. Other such method assigns priority to suggestions received from users who have higher scores, more credits, better performance (synchronicity) values, and/or higher rankings in their stored historical data.

The answer period also includes the countdown clock 304 indicating how much time is left for the group to collaboratively control the pointer 210 and target an answer. In many embodiments, this counter starts at 60 seconds. From here, the process proceeds using the methods for answering questions disclosed above, and in the co-pending patent applications that have been incorporated by reference.

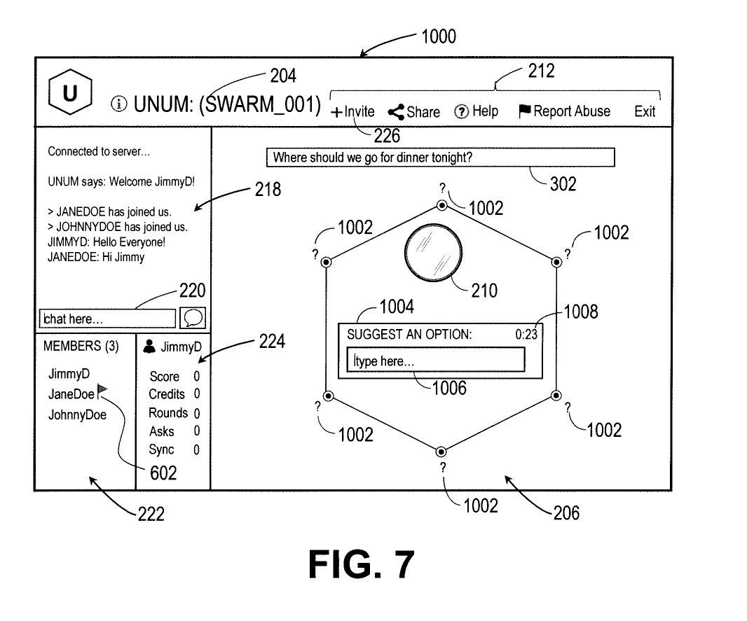

Referring next to FIG. 7, an exemplary group display interface 700 of one computing device 104 of the collaborative system 100 at a point in time immediately after the first user has submitted a question in suggestion mode is shown. Shown are the group name 204, the target area 206, the communication menu 212, the chat window 218, the chat input box 220, the current member list 222, the statistics display 224, the invite button 226, the question display 302, the flag icon 602, the plurality of input choice placeholders 1002, the suggestion dialog box 1004, the suggestion input field 1006, and the suggestion countdown timer 1008.

The exemplary display interface 700 of FIG. 7 is shown as it might be displayed by the CIA software running on one of the group computing devices 104, in response to the question being received from the CCS 102, that question being indicated as a suggestion mode question, i.e. during the display question and suggestion mode step 906. As shown in FIG. 7, the question is displayed by the CIA software to the user of this computing device 104, in the question display 302. As also shown in the FIG. 7, the suggestion dialog box 1004 is also displayed by the CIA software to the user, the suggestion dialog box 1004 including the suggestion input field 1006 for use by the user to input the suggestion. As also shown in the FIG. 7, the suggestion countdown timer 1008 is displayed to the user by the CIA software as triggered by an indication send from the CCS 102, counting down the number of seconds that are left for the group of users to provide suggestions.

As also displayed in FIG. 7, the plurality of input choice placeholders 1002 is displayed on the target area 206, the plurality of input choice placeholders 1002 that will be replaced by answer choices 208 selected from the suggestions received by the CCS 102. At the moment in time represented by FIG. 7, no suggestions have yet been displayed. In other words, the CCS 102 software is currently waiting for six suggestions (or optionally five, if “bad question” is to be automatically filled in as one of the choices as will be the case in this example).

Referring next to FIG. 8, an exemplary group display interface 838 of the computing device 104 of the collaborative system 100 during a second point in the suggestion period is shown. Shown are the group name 204, the target area 206, the plurality of answer choices 208, the pointer 210, the communication menu 212, the chat window 218, the chat input box 220, the current member list 222, the statistics display 224, the invite button 226, the question display 302, the magnet icon 306, the plurality of input choice placeholders 1002, the suggestion dialog box 1004, and the suggestion countdown timer 1008.

The time shown in the display interface 838 shown in FIG. 8 is during the loop of the user inputs suggestion step 908 through the fill target area step 912, i.e. after the user input question step 902, but before the suggestion time period indicated by the suggestion countdown timer 1008 has expired, and before the set of input choice placeholders 1002 has been filled with suggestions. Thus, at this moment in time depicted by FIG. 8, more suggestions can still be entered, thus the suggestion dialog box 1004 is still displayed on the display interface 838.

Also shown in FIG. 8 is a snapshot of the chat window 218 at one point in time during the suggestion period. As shown in FIG. 8, the chat window 218 displays the question asked, associated with the username of the user who submitted the question using the suggestion input field 1006 shown previously in FIG. 7. As also shown, the chat window 218 lists each of the suggestions submitted so far, and also indicates the username associated with the user who submitted that suggestion. In the example shown in FIG. 8, JimmyD asked the question, “Where should we go for dinner tonight?” in suggestion mode which was transmitted to the CCS 102, forwarded to the CIA software of each computing device 104, and displayed by the CIA software in both the chat window 218 and in the question display 302 of all the computing devices 104 in the group. The suggestion dialog box 1004 was then displayed in the target area 206 on all computing devices 104 of the members of the group, substantially simultaneously. The users were also given a 30 second suggestion time period to make suggestions, the suggestion time period indicated by the suggestion countdown timer 1008.

A plurality of users each entered suggestions on their own computing devices 104 which were sent by the CIA software on their computing devices 104 to the CCS 102 (the user inputs suggestion step 908) which were then sent to each of the computing devices 104 and displayed by the CIA software of each device 104 (the CCS sends suggestion step 910 and the fill target area step 912).

As shown in FIG. 8, each of the suggestions is displayed by the CIA software on the target area 206 as one answer choice 208, each answer choice 208 taking the place of one input choice placeholder 1002. The three answer choices 208 shown are “Taco Bell”, “Salad Farm” and “Red Lobster”. Because only three suggestions were entered thus far in this example, the other input choice placeholders 1002 continue to be display, in this example as “?” symbols.

Optionally displayed is an indication in the chat window 218 of the username of the user who submitted the suggestion. This is a configurable option, for some groups may not want to broadcast who makes suggestions, instead leaving them anonymous. This can be a setting of the group, as set in the lobby interface 800 when a group is created and/or configured. This can also be a setting of the question, when the user selects suggestion mode, indicating if suggestions will be anonymous or tagged with their username.

At this point in the multi-step process, the CCS 102 software determines if (a) the suggestion countdown timer 1008 is up, or (b) if all the target slots have been filled with suggestions, as previously described in the spots filled decision point 914 and the time period decision point 916 of FIG. 8. If so, assuming at least 2 suggestions were received, the CCS 102 software is configured to send a message to all the computing devices 104, telling them to end the suggestion period and enter the answer period of this multi-phase process. This message is sent such that all the computing devices 104 can start the answer period in a substantially simultaneous manner, as the real-time synchronous answering session requires substantial simultaneity. (Alternatively, the CCS 102 software may determine that the question is terminated due to lack of suggestions, as described previously).

This multi-step process that includes the suggestion period and the answer period is highly effective, for it allows the group to engage in the question and answer process that combines the benefits of asynchronous and synchronous interactions. For example, the group might comprise a small group of friends, allowing the group of friends to rapidly and definitively answer a question by deciding among a number of suggestions, converging upon an answer in a very short amount of time.

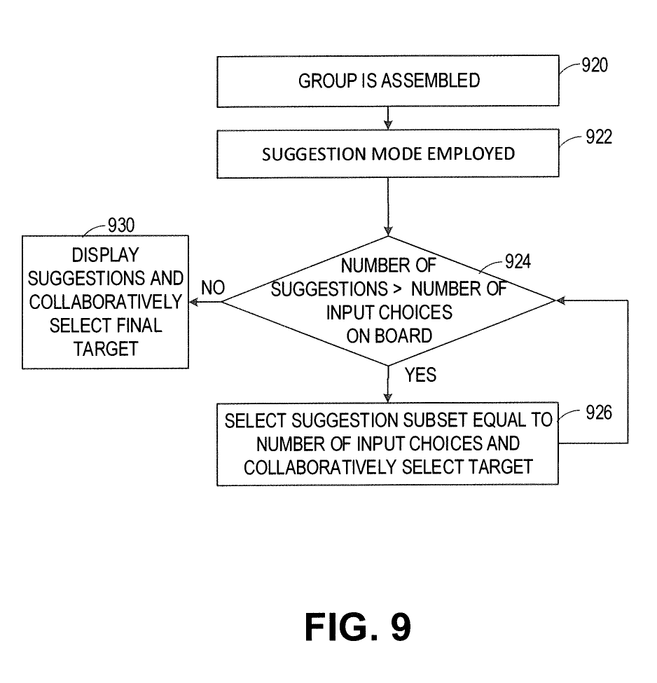

Referring next to FIG. 9, a flowchart diagram of an exemplary suggestion selection process of the real-time collaborative system 100 is shown. Shown are an assemble group step 920, an employ suggestion mode step 922, a number of suggestions decision point 924, a select suggestion subset step 926, and a final selection process step 930

The present invention can be described in term of the step-by-step methods by which a swarm of networked users can be enabled, under computer moderated control of the CCS 102, to generate a large set of suggestions in response to a prompt and then evaluate the large set of suggestions through an iterative process of presenting and selecting from among sub-sets of the full suggestion set.

In the first assemble group step 920, the system 100 enables the plurality of computing devices 104 to connect to the CCS 102, said plurality of computing devices 104 running local CIA software that communicates real-time bidirectional data 106 with the CCS 102 running CCS routines. The CIA software enables the display of prompts to the user of that device 104, said prompts including questions sent from the CCS 102 to all said computing devices 104 at substantially the same time, enabling the real-time synchronous response. The real-time prompt received from the CCS 102 and displayed by the CIA software may be a question, decision, notion, or action to be decided upon by the group (swarm) through the real-time synchronous collaborative process. In many embodiments, the prompt may be posed by a member of the swarm. In some embodiments, the prompt may be crafted by the swarm itself. In some embodiments, the prompt may come from another swarm, enabling to artificial collaborative intelligences to communicate/debate.

In the next employ suggestion mode step 922 the suggestion mode process is carried out via careful coordination of the CCS 102 software and the local CIA routines running on the plurality of computing devices 104, as previously described. This enables, through networked computer-moderation, the plurality of users to provide the plurality of suggestions to the CCS 102 through the substantially parallel, substantially real-time process. The plurality of suggestions are provided by said plurality users through the substantially simultaneous display of a prompt to each of said users on a computing device 104 associated with each users. In some embodiments, the CCS 102 is configured to tally the number of suggestions received and determine if a sufficient number of suggestions has been fielded from the users prior to a timer expiring. In some embodiments the timer is set to 20 seconds, encouraging all users to provide their suggestions quickly. In some embodiments a sufficient number of suggestions is defined to be a value between 20% and 70% of the total number of members in the swarm. In some embodiments, users are restricted from providing more than one suggestion in response to the CIA prompt. The CCS 102 compiles the suggestions into the suggestion list.

During the number of suggestions decision point 924, the CCS 102 compares the number of suggestions in the suggestion list to the number of input choice placeholders 1002 on the currently chosen target area 206. If the number of suggestions is greater than the number of input choice placeholders 1002 (i.e. all suggestions cannot be presented simultaneously on the target area 206), the process proceeds to the select suggestion subset step 926. If the number of suggestions is less than or equal to the number of input choice placeholders 1002, the process proceeds to the final selection process step 930.

In the select suggestion subset step 926, the CCS 102 selects a subset of the suggestion list wherein the number of suggestions in the subset is equal to the number of input choice placeholders 1002 of the target area 206. In a first instance of the select suggestion subset step 926 (during a first round), a first subset of suggestions equal to the number of answer choices 208 of the target area 206 is selected. For subsequent rounds, the suggestion selected as the target from the previous round is included in the suggestion subset, and additional suggestions are chosen from the suggestion list to fill in the remainder of the answer choices 208. If a suggestion was included in a previous selection round but was not selected, that suggestion is not included in additional subsets. In other words, the target from the previous round is kept on the target area 206 and the non-selected answer choices 208 are replaced by suggestions that have not been previously considered using the collaborative decision-making process. The CCS 102 then sends indications of the suggestion subset to the computing devices 104, and the suggestion items are displayed as the answer choices 208 on the target area 206. In some embodiments the first selection remains in the slot it held in the prior round. In some embodiments the first selection is moved to a randomly selected spot on the target area 206. For example, a different location around the hexagon target area 206 of FIG. 2. The collaborative selection process is carried out as described in the co-pending applications, and the target is collaboratively selected from among the answer choices 208. The process then returns to the number of suggestions decision point 924.

When the number of suggestions is equal to or fewer than the number of input choice placeholders 1002, the process continues to the final selection process step 930. In the final selection process step 930, all of the remaining suggestions are displayed as answer choices 208 on the target area 206 and the collaborative process is carried out, whereby the target is collaboratively selected from the plurality of answer choices 208, and the target selected is a final target (answer).

In this way, a large number of suggestions which would have been unmanageable for users to consider all at once are presented in subsets, each subset yielding a target selection which is then presented along with a new subset for another round of consideration, iterating until the selection of the final target is achieved.

Referring again to FIG. 9, while the suggestion mode described above in FIG. 5 and in application Ser. No. 14/920,819 enables groups of users to form a collaborative intelligence that can answer questions, make decisions, or take actions by first collecting a set of suggestions from members of a real-time collaborative group (i.e. swarm), the current methods and systems are not ideal for handling a set of suggestions provided from mid-size and large-scale groups. For small groups, for example groups of less than 20 users, it is often highly functional to collect the first 6 to 10 suggestions and display them all at once in a single selection process as described in FIG. 5. For massive groups, that might include hundreds or thousands or even millions of users, the inventive parallel processing method has been disclosed by the current inventor in co-pending application Ser. No. 14/925,837 as incorporated by reference. But, mid-size groups in the range of approximately 20 to 200 users are not ideal for either of the prior disclosed approaches. What is needed is a method for supporting many dozens of suggestions, but not resorting to the overhead requirements of parallel processing.

Consider, for example, a mid-size swarm of 50 users, all of said 50 users engaging their own computing device 104, each of said computing devices 104 running the CIA in networked communication with the CCS 102. The methods and systems disclosed thus far herein have the capacity collect substantially simultaneous suggestions from all 50 individuals, or at least a substantive percentage of those individuals, thus resulting in a highly creative collaborative swarm. What is needed, however, is fast and efficient systems and methods by which a mid-sized swarm of users can evaluate a large number of suggestions and converge on a single solution. The problem is, no single individual can consider and evaluate large numbers of suggestions in a rapid and real-time manner.

For example, if half of the 50 individuals in a swarm each provided a suggestion, that would comprise a suggestion set of 25 suggestions. Each of said individuals, using their own computing device 104 would need time to read all 25 suggestions, compare their relative merits, and pick a preferred option. This would be slow and dull for a real-time environment, users waiting for other users to finish their evaluation. In addition, it's very difficult for a group to reach a highly agreeable consensus when comparing a large number of options. That's because a large number of options splits the group into many tiny factions, each vying for one of the large number of options. As a result, in many cases, most options may have only a few supporters. Thus a very small number of supporters may be enough to cause the group to make a decision. Such a decision is highly unlikely to be agreeable to a large percentage of the group. To get a high degree of agreeability (i.e. satisfaction) it has been determined by the present inventor that groups need to weigh smaller sets of suggestions, find consensus, and then consider additional options and find consensus again through iteration. This is because each decision process has fewer options and thus fewer factions vying for alternatives. The result is a unique process in which the odds of high agreeability and satisfaction are high.

As an example, consider a group trying to decide what type of food to have for dinner. If the group has 10 people and they are presented with 10 options, their views are split into a large number of factions. A faction of 3 users may desire Indian food. All of the other users may be split among the remaining options—Italian, Chinese, Mexican, French, American, Thai, and Korean. The group in this case would likely converge upon Indian food because it has the largest faction, all the other inputs being split, canceling each other out. In fact, even if a majority of participants did not want Indian food, it still may emerge as the answer because of the large number of options relative to the number of participants. But, if this same question was asked through two iterative rounds, each round having only 5 options, users would be more likely form factions with higher numbers of participants. A single best choice would emerge. That best choice could then be pitted against the remaining five choices. This two stage iterative process, each with larger factions, is more likely to achieve a solution that is agreeable to the will of the group. In other words, it evokes a more accurate collaborative intelligence.

Referring again to the example above, for 50 users choosing among 25 options, the computer moderated process disclosed herein allows for a more pleasant, less boring, and more accurate decision process by presenting those options in iterative rounds. For example, each round could comprise 5 or 6 options, each pitted against the winner of the previous round. This allows for a decision in 5 rounds which has less downtime for dull reading and comparing solutions. This also reduces the chance that the large group is split so thin, no answer is achieved that is highly agreeable to a large percentage of the group.

As described herein, the inventive methods and systems involve the innovative use of computer moderated iterative rounds orchestrated by code running on the CCS in which repeated subsets of the full set of suggestions are presented for evaluation and selection by the real-time synchronous collaborative group, each round resulting in a group selection that is then presented by the system 100 along with a new subset, for another round of selection. This process repeats until all the suggestions in the full set have been evaluated. The process ends with a final selection. In this way, the problem of considering and evaluating the large number of suggestions is divided among manageable rounds under computer moderated control of the CCS 102.

Turning to the specifics of how the CCS 102, working in conjunction with CIA software running on each portable computing device 104 moderates the iterative process, consider a swarm of 50 users, all of said 50 users engaging their own computing device 104, each of said computing devices 104 running CIA software that's in networked communication with the CCS 102. A question is asked by one of said users, employing the suggestion mode disclosed previously. The CCS 102 software sends a representation of the question to all 50 computing devices 104 of all 50 users, triggering the CIA software running on said computing devices 104 to display the suggestion box on the screens of the computing devices 104 of those users. The suggestion timer 625 is also displayed to those users, requiring all users to act rapidly, providing suggestions to the question or other prompt that appeared.

As users enter suggestions into the suggestion box displayed by the CIA software on their computing devices 104, those suggestions are communicated from each computing device 104 back to the CCS 102 for processing. The CCS 102 collects all the suggestions in memory, keeping a running tally of the number of suggestions. The collection process ends when either (a) the timer runs out, or (b) when a desired number of suggestions is collected. In some embodiments, a desired number of suggestions is set to be a certain percentage of the total number of users in the swarm. In one such embodiment, the desired number of suggestions is set to 50% of the number of users in the swarm. This is an effective size because (a) it assures that a large portion of the total user base has participated, and (b) it allows users not to participate if they simply don't have a suggestion to give. In general, a desired number of suggestions is configured in the CCS 102 software to be somewhere between 20% and 70% of the total swarm size.

In this example, the CCS 1-2 software waits until 50% is reached, which corresponds to a set of 25 suggestions provided by the example swarm of 50 members. The CCS 102 is then operative to begin the computer moderated evaluation and decision process by defining selecting a first subset of the full set of 25 suggestions and presenting that first subset to the group of 50 users in a first round collaborative selection process. The CCS 102 is configured to size the first subset to a number of suggestions that can be easily and quickly reviewed and compared by the participants. In this example the CCS 102 is configured to present synchronous collaborative questions with six answer choices 208 to choose among, as shown in the example answer choice 208 set of FIG. 2. Thus the CCS 102 is operative to select a first subset of 6 suggestions for the first round collaborative selection process. In other words, the CCS 102 is configured to select a subset of the full set sized by the number of answer choices to be displayed on the collaborative interface of each users.

It should be noted that there may be natural duplicates of many of the suggestions resulting from the fact that some members of the swarm of users may have provided similar suggestions. This is generally not a problem, for the bias washes across multiple rounds. That said, some embodiments of the CCS 102 software can be configured to check for and eliminate substantially duplicate suggestions in the suggestion list.

Whether duplicates are eliminated or not, the CCS 102 software is configured to divide the total set of suggestions of the suggestion list into subsets, the first subset matching the number of answer choices 208 in the display board, each subsequent subset being sized as the number of answer choices 208 in the display board for that round. Each subsequent round includes the selected suggestion from the previous round, so the number of previously unshown answer choices for subsequent rounds is one less than the total number of answer choices 208. The display of each subset during each round is enabled by the CIA software running on the computing device 104, which enables users to be tasked with evaluating and select from among the provided subsets. The iterative round process then repeats, subset after subset being presented and selected from among by the users under the coordination of the CCS 102.

Referring next to FIG. 10, an exemplary initial suggestion list 1012 and initial target area 1010 of a display interface of the computing device 104 of the collaborative system 100 during suggestion mode is shown. Shown are the question display 302, the plurality of input choice placeholders 1002, the suggestion dialog box 1004, the suggestion countdown timer 1008, and the initial suggestion list 1012.

An embodiment of the suggestion process described in FIG. 9 can be explained with respect to an example as illustrated by FIGS. 10-13. In this example, a group 63 users are participating in a real-time collaborative swarm such that they can answer questions by moving the graphical pointer 210 to one of six answer choices 208 displayed. As shown in FIG. 10, a question has been entered by one of the users consistent with the employ suggestion mode step 922 described above in FIG. 9. In this example, the question is, “Who will win the Super Bowl in the 2016 season?”

This question is identified as being asked in suggestion mode consistent with the suggestion mode previously described. This identification may be achieved by the user having selected “suggestion mode” from a menu of various modes. As a result of this identification, all 63 users are displayed the suggestion dialog box 1004 on their computing devices 104, and can respond by entering the suggestion which gets sent to the CCS 102. In this example, 20 of the 63 users enter suggestions, with each suggestion being the name of an NFL football team. The CCS 102, in this example, culls duplicates from the list of received suggestions, yielding the initial suggestion list 1012 of 16 unique suggestions.

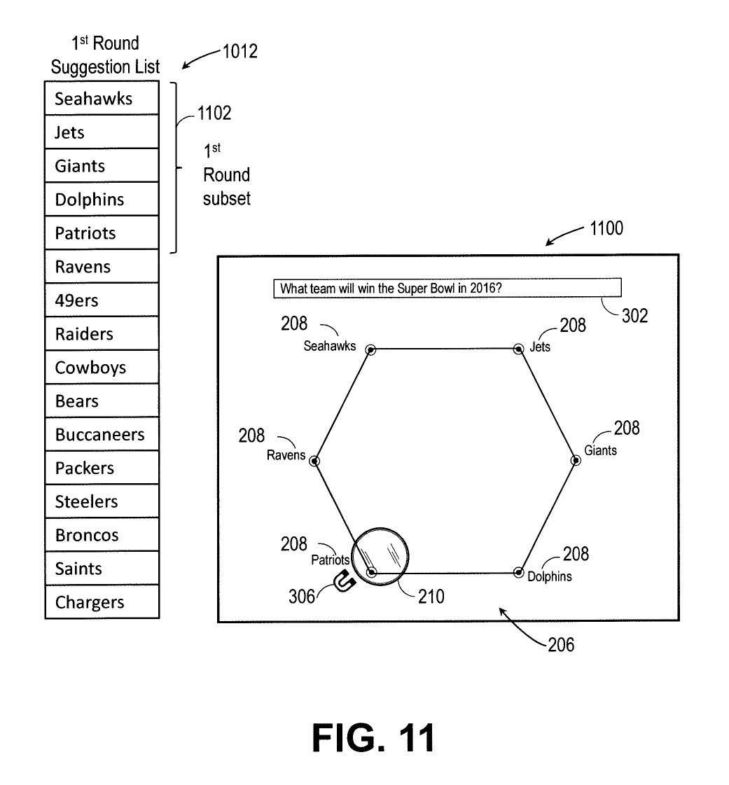

As described in the number of suggestions decision point 924, the CCS 102 determines that the number of suggestions (16) is larger than the number of answer choices 208 in the initial target area 1010 being used by the system 100 (six, as indicated by the input choice placeholders 1002 shown in FIG. 10). That's because the initial target area 1010 includes a hexagon shape configured for 6 answer choices 208 in this example. Thus the CCS 102 engages the automated computer-moderated process such that the users will review and choose among the full (initial) suggestion list 1012 through the series of iterative rounds. In this example, three rounds is sufficient for the users to consider and choose among the full initial suggestion list 1012 (set) of 16 suggestions collected from the group. The suggestions in the first suggestion subset are then displayed as answer choices 208 on the first round target area 1100, as shown below in FIG. 11, and the collaborative selection process begins.

Referring next to FIG. 11, an exemplary first round suggestion subset 1102 and exemplary first round target area 1100 of the computing device 104 of the collaborative system 100 during a first round of the suggestion selection process is shown. Shown are the pointer 210, the question display 302, the magnet icon 306, the plurality of answer choices 208, the initial suggestion list 1012 and the first round suggestion subset 1102.

The first round target area 1100 of FIG. 11 is shown during the collaborative selection process of the first round suggestion subset 1102. The first round suggestion subset 1102 as shown includes the following six teams: Seahawks, Jets, Giants, Ravens, Dolphins, and Patriots. These six suggestions have been communicated to the portable computing devices 104 of all users and displayed as answer choices 208 around the hexagon shape. The users then engage in the collaborative real-time synchronous decision-making process in which the collaborative intelligence is evoked through the user of the closed-loop feedback process. In this example, the Patriots answer choice 208 is being selected by the collaborative group as the target (answer) to the question among the six suggestion first round suggestion subset 1102 presented. Thus Patriots is the first target selection in the iterative suggestion selection process.

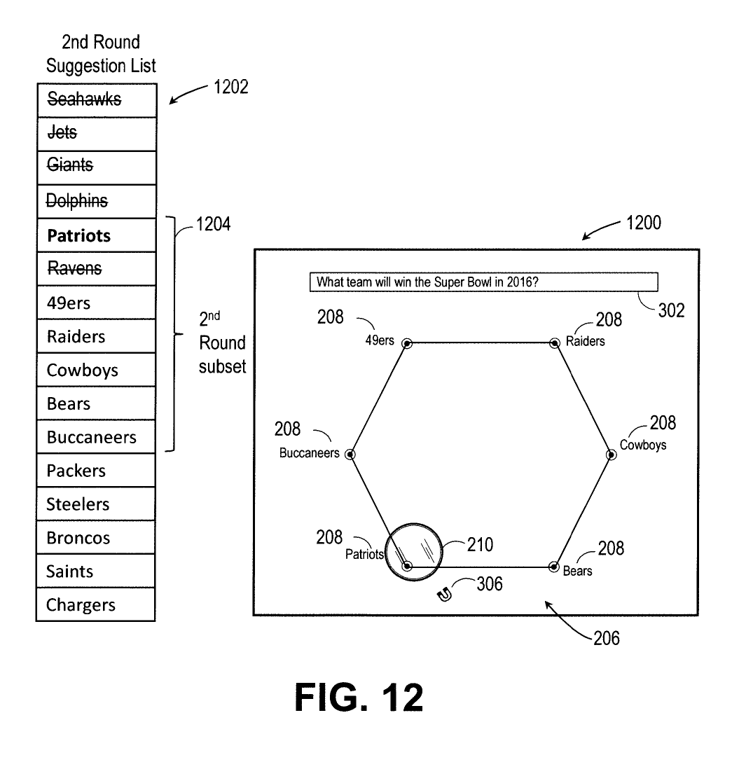

Referring next to FIG. 12, an exemplary second round suggestion list 1202 and second round target area 1200 of the computing device 104 of the collaborative system 100 during a second round of the suggestion selection process is shown. Shown are the pointer 210, the question display 302, the magnet icon 306, the plurality of answer choices 208, the second round suggestion list 1202 and the second round suggestion subset 1204.

As previously described the CCS 102 then checks whether the number of suggestions remaining (including the target selected in the first round) is greater that the number of answer choices 208. In the example shown, the second round suggestion list 1202 includes 11 suggestions, which is greater than the number of available answer choices 208, six (6). Therefore, the process continues to another subset selection round. The CCS 102 identifies and communicates the second round suggestion subset 1204 of suggestions to the computing devices 104. The first target from round one (Patriots in this example) remains as one of the answer choices 208. Thus the CCS 102 selects 5 new (i.e. not previously displayed as an answer choice 208) suggestions from the second round suggestion list 1202: 49ers, Raiders, Cowboys, Bears, Buccaneers. These five answer choices 208, along with Patriots from the previous round, now constitute the answer choices for the second round of collaborative decision making. The users then engage in the collaborative real-time synchronous decision making process in which the collaborative intelligence is evoked through the use of the closed-loop feedback process. As shown in FIG. 12, Patriots is being selected again by the collaborative group as the best answer (target) to the question among the six suggestions presented as answer choices 208. Thus Patriots is also the second selection in the iterative process.

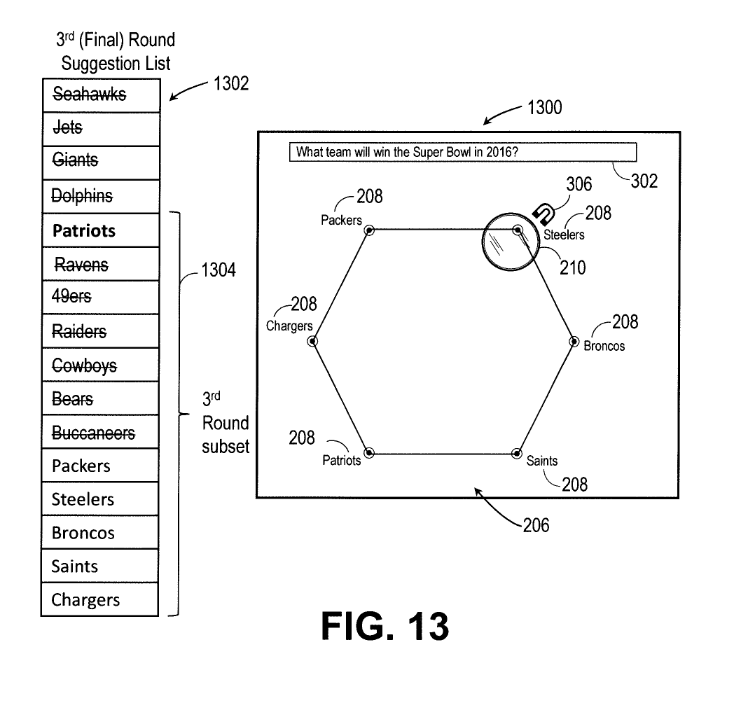

Referring next to FIG. 13, an exemplary third round suggestion list 1302 and third round target area 1300 of the computing device 104 of the collaborative system 100 during a third round of the suggestion selection process is shown. Shown are the pointer 210, the question display 302, the magnet icon 306, the plurality of answer choices 208, the third round suggestion list 1302 and the third round suggestion subset 1304.

As previously described the CCS 102 then checks whether the number of suggestions remaining (including the target selected in the first round) in the third round suggestion list 1302 is greater that the number of answer choices 208. In the example shown, the third round suggestion list 1302 includes 6 suggestions, which is equal to the number of available answer choices 208, six. Therefore, the remaining suggestions (the target from the previous round plus any yet undisplayed suggestions) may all be displayed on the third round target area 1300 and the third round will be the final round. Thus the CCS 102 sends 5 new suggestions (the third round suggestion subset 1304) from the list of suggestions: Packers, Steelers, Broncos, Saints, and Chargers. These five suggestions, along with Patriots from the prior round, now constitute the answer choices 208 for the third and final round of collaborative decision making. The users then engage in the collaborative real-time synchronous decision making process in which the collaborative intelligence is evoked through the use of the closed-loop feedback process. In this example, Steelers is being selected by the collaborative group as the best answer (target) to the question among the six answer choices 208 presented. Thus Steelers is the third selection in the iterative suggestion selection process. And, because there are no more suggestions in the initial suggestion list 1012 that have not yet been considered, the CCS 102 determines that Steelers is the final answer selection for this question.

The final selection is then identified in a communication from the CCS 102 to the plurality of computing devices 104 running CIA software. The final selection is displayed to all users. In many embodiments, stats are also displayed, for example, the total selection time that was used by the group to answer the question. The total selection time is a summation of the time used by the group during each of the rounds of collaborative decision making. In this case it would be the time used during the first, second, and third rounds of decision making. In some embodiments, points are awarded to the users if the total selection time is less than a threshold value, thus encouraging rapid decision making. In most embodiments, a countdown timer is displayed during the selection process as well.

Thus the aforementioned iterative suggestion selection process allows the group of networked users to receive the question (or other prompt) on each personal computing device 104 and to collectively provide the plurality of real-time suggestions in response to said question (or other similar prompt). The present invention further allows the group of networked users to collaboratively consider and evaluate the set of suggestions, narrowing the set of suggestions through an iterative process that results in the final selection.

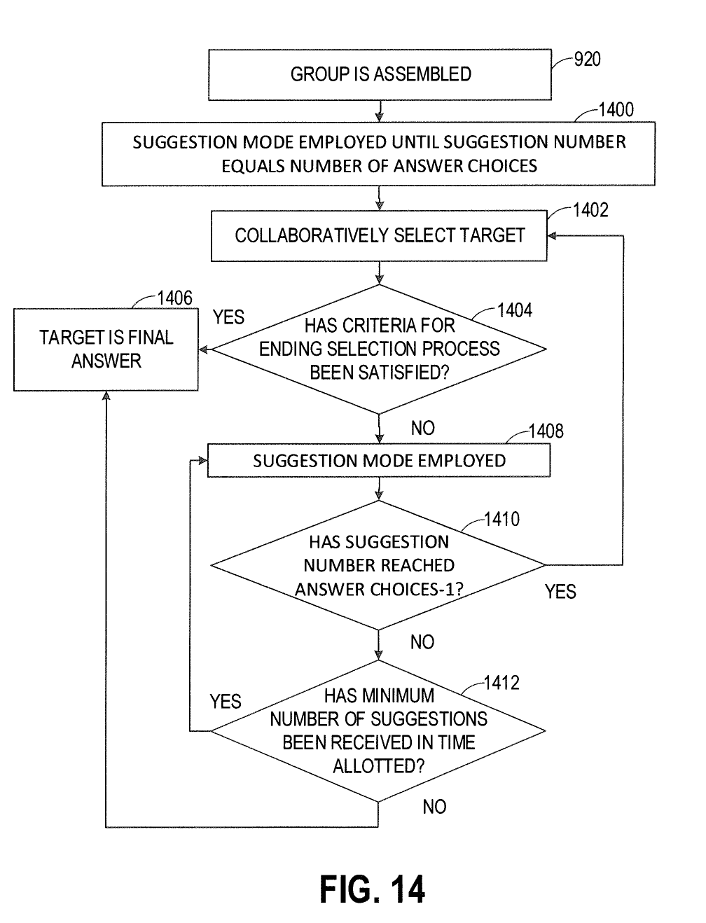

Referring next to FIG. 14, a flowchart diagram of an iterative suggestion selection process in another embodiment of the real-time collaborative system 100 is shown. Shown are the first assemble group step 920, a receive number of suggestions step 1400, a select target step 1402, a selection process ended decision point 1404, a final answer step 1406, an additional suggestion mode step 1408, a max suggestion number decision point 1410, and a minimum number of suggestions decision point 1412.

Similarly to the iterative suggestion process of FIG. 9, the collaborative group is assembled in the first assemble group step 920. The target area 206 configured to display a number of available answer choices 208 for collaborative selection is determined by the CCS 102 or one user.

In the next receive number of suggestions step 1400, the suggestion mode process is carried out until a number of suggestions are received by the CCS 102 and added to the suggestion list. In this embodiment, the number of suggestions equals the number of available answer choices 208. The CCS 102 sends an indication of the suggestions to the computing devices 104, whereby the suggestions are displayed as the answer choices 208. The process then proceeds to the select target step 1402.

During the select target step 1402, users collaboratively select the target from the displayed answer choices 208, using the methods previously described.

The process then proceeds to the selection process ended decision point 1404. During the selection process ended decision point 1404, the CCS 102 determines, using previously set criteria, whether the iterative suggestion selection process is ended. In one embodiment, the suggestion selection process is ended when a number of collaborative selections have been completed. If the CCS 102 determines that the selection process is ended, the process proceeds to the final answer step 1406, and the previously selected target is the final answer. If the CCS 102 determines that the selection process is not ended, the process proceeds to the additional suggestion mode step 1408.

In the additional suggestion mode step 1408, the suggestion mode process is carried out, eliciting new suggestions from the users and adding the suggestions to a new suggestion list. The process then proceeds to the max suggestion number decision point 1410.

In the max suggestion number decision point 1410, if the CCS 102 has received a number of suggestions equal to the number of answer choices minus one, the suggestions, along with the previously selected target, are sent to the computing devices 104 and displayed as answer choices 208. The process then returns to the select target step 1402, the CCS 102 sends an indication of the suggestions to the computing devices 104, and the users collaboratively select a new target from the answer choices 208, using the methods previously described.

If in the max suggestion number decision point 1410, the number of suggestions has not reached the number of answer choices minus one, the process proceeds to the minimum number of suggestions decision point 1412. If in an allotted time a number of suggestions has not reached a minimum number of suggestions, the process proceeds to the final answer step 1406 and the previously selected target is the final answer. If a minimum number of suggestion has been received, the process continues and returns to the additional suggestion mode step 1408, and users may submit additional suggestions.

The suggestion process shown in FIG. 14 of providing suggestions is moderated by the CCS 102 software in a different manner is called herein as the “Top This” paradigm. In the “Top This” paradigm, the CCS 102 software only allows the number of suggestions to be provided that fit on the target area 206 (for example six suggestions in the exemplary hexagonal target area 206). This said, the CCS 102 software is configured at the end of the selection process among those initial suggestions, to re-trigger the suggestion prompt to all users such that it appears on their computing devices 104, the suggestion prompt now asking the users if they have any additional suggestions that might “top” the previously selection suggestion. These additional suggestions are accepted by the CCS 102, up to one-minus the number of answer choices 208 on the target area 206 (5 suggestions, in this example). These additional suggestions are presented along with the suggestion selected from the prior round. The users can now select a new suggestion, or re-select that previously selected suggestion. When the selection is made the process repeats again, the users being prompted for more suggestions that can “top” the previous selection. This process can be configured to repeat a set number of times, or can be configured to repeat until the users cease providing suggestions in response to the “Top This” prompt.

In some embodiments, the number of round iterations is computed based on the number of users divided by the number of answer choices 208 on the target area 206. For example, if there were 50 users and 6 answer choices 208 on the target area 206, the system 100 can be configured to repeat the “Top This” sequence up to N times where N=50%×(# of users/(answer choices-1)) or50%×(50/(6-1)=5 times for the example of 50 users and 6 answer choices 208. This would allow suggestions from half of the full set of users.

Also, duplicates can be culled during this method as well, thus increasing the number of suggestions that can be collected during each round. Also, suggestions that duplicate an already considered suggestion from a prior round can be culled in real time, thus increasing the efficiency and number of suggestions that can be collected during each round. In some embodiments a “smart culling” routine is enabled such that duplicates are matched even if they have slightly different capitalization, wording, or spelling. For example, “The 49ers” and “49ers” could be matched as a duplicate using smart culling.

While many embodiments are described herein, it is appreciated that this invention can have a range of variations that practice the same basic methods and achieve the novel collaborative capabilities that have been disclosed above. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. An iterative suggestion selection process for a group of users in real-time collaborative control of at least one graphical object, each user of the group associated with one of a plurality of computing devices, each computing device including a display interface, configured to exchange data with a collaboration server, and run a collaboration application, the collaboration server performing the steps of:
receiving, during a suggestion period, from the plurality of computing devices, a plurality of representations of suggestions;
adding each of the plurality of representations of suggestions to a suggestion list;
determining that a number of representations of suggestions of the suggestion list is greater than a pre-determined number of answer choices;
selecting a first subset of the plurality of representations of suggestions equal to the number of answer choices;
sending an indication of the first subset to the plurality of computing devices;
moderating a collaborative selection process, whereby a first target is collaboratively selected from the first subset by the group of users;
while a number of representations of suggestions not previously included in at least one collaborative selection process is greater than a pre-determined number of answer choices minus one, repeatedly performing the steps of;
selecting a revised subset of the plurality of representations of suggestions, wherein the revised subset excludes all representations of suggestions previously included in one collaborative selection process but not selected as the target, and wherein the revised subset includes the target of the previous collaborative selection process;
sending an indication of the revised subset to the plurality of computing devices; and
moderating a next collaborative selection process, whereby a revised target is collaboratively selected from the revised subset by the group of users;
selecting a final subset of the plurality of representations of suggestions, wherein the final subset excludes all representations of suggestions previously included in at least one collaborative selection process but not selected as the target, and wherein the final subset includes the target of the previous collaborative selection process;
sending an indication of the final subset to the plurality of computing devices; and
moderating a final collaborative selection process, whereby a final target is collaboratively selected from the final subset by the group of users.

2. The iterative suggestion selection process of claim 1, wherein the iterative suggestion selection process is preceded by a suggestion mode process including the steps of:
receiving by the collaboration server of a representation of a question from a first computing device of a first user of the group; and
sending of the representation of the question and a suggestion mode indication to each of the plurality of computing devices, whereby each collaboration application updates the display interface to display the representation of the question, the suggestion mode indication and a suggestion input field configured to receive input.

3. The iterative suggestion selection process of claim 1, wherein the sending an indication of the revised subset to the plurality of computing devices includes displaying the target of the previous collaborative selection process in a same location on the display interface as in the previous collaborative selection process.

4. The iterative suggestion selection process of claim 1, wherein the sending an indication of the revised subset to the plurality of computing devices includes displaying the target of the previous collaborative selection process in a different location from the location in the previous collaborative selection process.

5. The iterative suggestion selection process of claim 1, wherein the collaboration server removes duplicates from the suggestion list.

6. The iterative suggestion selection process of claim 1, wherein a countdown timer is displayed during each collaborative selection process.

7. The iterative suggestion selection process of claim 1, wherein points are awarded to users of the group based at least in part on a time length of the iterative suggestion selection process.

8. The iterative suggestion selection process of claim 1, wherein each of the plurality of representations of suggestions is associated with each computing device sending the suggestion, whereby each of the plurality of representations of suggestions is associated with at least one user, and wherein the at least one user associated with a representation of a suggestion chosen as the final target is awarded points.

9. A system for an iterative suggestion selection process for a group of users in real-time collaborative control of at least one graphical object, comprising:
a group of a plurality of computing devices, each user of the group associated with a user, each computing device each comprising a communications infrastructure coupled to each of a processor, a memory, a timing circuit, a display interface coupled to a display and configured to receive input from a user;
a collaborative intent application stored on each memory and configured to run on each processor to:
convey to the user, using the display interface, a group collaboration opportunity,
receive, repeatedly in real-time, user input of a user intent vector through the display interface,
send, repeatedly in real-time, the user intent vector to a collaboration server,
receive, repeatedly in real-time, a group intent vector from the collaboration server, and
present, repeatedly in real-time, a graphical indication of the group intent vector to the user using the display interface; and
the collaboration server in networked communication with the plurality of computing devices, the collaboration server including a server processor and a server memory, the processor configured to run a collaboration mediation application stored on the server memory, the collaboration mediation application configured to perform the steps of:
receiving, during a suggestion period, from the plurality of computing devices, a plurality of representations of suggestions;
adding each of the plurality of representations of suggestions to a suggestion list;
determining that a number of representations of suggestions of the suggestion list is greater than a pre-determined number of answer choices;
selecting a first subset of the plurality of representations of suggestions equal to the pre-determined number of answer choices;
sending an indication of the first subset to the plurality of computing devices;
moderating a collaborative selection process, whereby a first target is collaboratively selected from the first subset by the group of users;
while a number of representations of suggestions not previously included in at least one collaborative selection process is greater than the pre-determined number of answer choices minus one, repeatedly performing the steps of;
selecting a revised subset of the plurality of representations of suggestions, wherein the revised subset excludes all representations of suggestions previously included in one collaborative selection process but not selected as the target, and wherein the revised subset includes the target of the previous collaborative selection process;
sending an indication of the revised subset to the plurality of computing devices;
moderating a next collaborative selection process, whereby a revised target is collaboratively selected from the revised subset by the group of users;
selecting a final subset of the plurality of representations of suggestions, wherein the final subset excludes all representations of suggestions previously included in at least one collaborative selection process but not selected as the target, and wherein the final subset includes the target of the previous collaborative selection process;
sending an indication of the final subset to the plurality of computing devices; and
moderating a final collaborative selection process, whereby a final target is collaboratively selected from the final subset by the group of users.

10. The system for the iterative suggestion selection process of claim 9, wherein the iterative suggestion selection process is preceded by a suggestion mode process including the steps of:
receiving by the collaboration server of a representation of a question from a first computing device of a first user of the group; and
sending of the representation of the question and a suggestion mode indication to each of the plurality of computing devices, whereby each collaboration application updates the display interface to display the representation of the question, the suggestion mode indication and a suggestion input field configured to receive input.

11. The system for the iterative suggestion selection process of claim 9, wherein the sending an indication of the revised subset to the plurality of computing devices includes displaying the target of the previous collaborative selection process in the same location as in the previous collaborative selection process.

12. The system for the iterative suggestion selection process of claim 9, wherein the sending an indication of the revised subset to the plurality of computing devices includes displaying the target of the previous collaborative selection process in a different location from the location in the previous collaborative selection process.

13. The system for the iterative suggestion selection process of claim 9, wherein the collaboration server removes duplicates from the suggestion list.

14. The system for the iterative suggestion selection process of claim 9, wherein a countdown timer is displayed during each collaborative selection process.

15. The system for the iterative suggestion selection process of claim 9, wherein points are awarded to users of the group based at least in part on a time length of the iterative suggestion selection process.

16. An iterative suggestion selection process for a group of users in real-time collaborative control of at least one graphical object, each user of the group associated with one of a plurality of computing devices, each computing device including a display interface, configured to exchange data with a collaboration server, and run a collaboration application, the collaboration server performing the steps of:
receiving, during a first suggestion period, from the plurality of computing devices, a number of representations of suggestions equal to a number of displayed answer choices;
adding each of the representations of suggestions to a first suggestion list;
sending an indication of the first suggestion list to the plurality of computing devices, wherein the representations of suggestions are displayed as answer choices on each display interface;
moderating a first collaborative selection process, whereby a target is collaboratively selected from the answer choices by the group of users;
receiving, during an additional suggestion period, from the plurality of computing devices, a number of representations of suggestions no more than a number of displayed answer choices minus one;
while a minimum number of suggestions is received in an allotted time, repeatedly performing the steps of;
adding each of the representations of suggestions to a next suggestion list;
sending an indication of the next suggestion list to the plurality of computing devices, wherein the representations of suggestions and the target are displayed as answer choices on each display interface;
moderating a next collaborative selection process, whereby a new target is collaboratively selected from the answer choices by the group of users and the new target replaces the previously selected target; and
receiving, during an additional suggestion period, from the plurality of computing devices, a number of representations of suggestions no more than a number of displayed answer choices minus one; and
setting of the new target as a final answer.

17. The iterative suggestion selection process of claim 16, wherein after moderating the first collaborative selection process, the collaboration server performs the steps of:
determining if a criteria for ending the iterative suggestion selection process has been satisfied; and
upon determining that the criteria for ending the iterative suggestions selection process has been satisfied, setting of the selected target as the final answer.

18. The iterative suggestion selection process of claim 17, wherein the criteria for ending the selection process includes receiving a minimum number of suggestions in an allotted time.

19. The iterative suggestion selection process of claim 17, wherein the criteria for ending the selection process includes the selection process being repeated a set number of times.

20. The iterative suggestion selection process of claim 17, wherein the criteria for ending the selection process includes receiving input from a minimum number of users in an allotted time.
